(19) United States
(12) Patent Application Publication
(10) Pub. No.: US 2007/0076102 A1
(43) Pub. Date: Apr. 5, 2007

(54) IMAGE CONTROL APPARATUS

(76) Inventor: Osamu Date, Saitama (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/536,719

(22) Filed: Sep. 29, 2006

(30) Foreign Application Priority Data
Oct. 3, 2005 (JP) P2005-289523

(51) Int. Cl. H04N 5/76

(52) U.S. Cl. 348/231.99

(57) ABSTRACT

Upon receiving an image file to be moved and designation of a movement destination of the image file, a movement designation receiver notifies a file mover and a slide show file identifier searcher of an image file identifier of the image file to be moved and the movement destination thereof. The slide show file identifier searcher searches a mapping information table for a slide show file identifier of the slide show file mapped to the image file identifier. An image file reference location rewriting unit rewrites an image reference location in the slide show file stored on a slide show file storage unit in accordance with the slide show file identifier.

### CROSS REFERENCES TO RELATED APPLICATIONS

The present invention contains subject matter related to Japanese Patent Application JP 2005-289523 filed in the Japanese Patent Office on Oct. 3, 2005, the entire contents of which are incorporated herein by reference.

### BACKGROUND OF THE INVENTION

1. Field of the Invention

The present invention relates to an image control apparatus, a processing method, and a computer program and, in particular, to an image control apparatus, a processing method, and a computer program for processing a slide show file that describes the content of a slide show in which image files are reproduced successively in order.

2. Description of the Related Art

Application programs for producing a slide show using files of images that are picked up using an image pickup device such as a digital camera are currently in widespread use. In the slide show, such application programs allow improvements to be implemented in transition effects that take place in transition from a preceding image file to a next image file, movement to be added to a displayed image file, a music file to be reproduced as back music during slide show, or a user to verify an image file picked up by the user.

Japanese Unexamined Patent Application Publication No. 10-145730 discloses a reproducing apparatus using one slide show technique. The reproducing apparatus allows music to be reproduced together with still images file with the still image files successively reproduced one after another. Music is thus continuously reproduced in a manner free from time limitation of the display of the still image file.

The slide show is typically performed using slide show files. Considered as methods of the slide show file are two types of methods, namely, an external reference method and a self-contained method. In the external reference method, a slide show file contains reference information referencing an image file, external to the slide show file, forming the slide show, and information relating to effects such as transitions. In the self-contained method, a single moving image file contains an image file forming the slide show and information relating to effects such as transitions. In the production of the slide show file, the user sets a desired transition effect, a music file as back music, and movement of the image file.

### SUMMARY OF THE INVENTION

When a slide show is performed using an external reference slide show file, an image file cannot be referenced in the slide show if the image file is shifted in the storage location thereof. The slide show is thus performed with the image file missing. The slide show itself may not be performed as a result of a triggered execution error.

Setting a desired transition effect, a music file as back music, and movement of the image file in the production of the slide show is troublesome to the user, and may discourage the willingness to produce slide shows.

It is thus desirable to provide an image control apparatus that produces a slide show file that allows a slide show to be continuously performed with no image file missing even if any image file moved in the storage location thereof.

In accordance with one embodiment of the present invention, an image control apparatus includes an image file storage unit for storing an image file, a slide show file storage unit for storing a slide show file describing the content of a slide show through which each image file is reproduced successively in order, a movement designation receiving unit for receiving the image file to be moved and designation of a movement destination of the image file, a file moving unit for moving the image file to the movement destination in accordance with the designation, a mapping information table for mapping an image file identifier of the image file to be used in the slide show to a slide show file identifier of the slide show file, and a slide show file correcting unit for correcting, in accordance with the movement destination, a reference location of the image file in the slide show file having a slide show file identifier corresponding to the image file identifier of the designated image file. Even if the image file is shifted in location, the provided slide show file executing the slide show is reproduced with no possibility of the image file missing.

The slide show file correcting unit may include a slide show file identifier search unit for searching the mapping information table for the slide show file identifier corresponding to the image file identifier of the image file designated by the movement designation receiving unit, and an image file reference location rewriting unit for rewriting, in accordance with the movement destination, the reference location of the image file used in the slide show of the slide show file having the slide show file identifier found in the search. The reference location of the image file in the slide show file is rewritten in accordance with the image file identifier, the slide show file identifier, and the transfer destination.

The image control apparatus may further include a music file storage unit for storing a music file, a slide show template file storage unit for storing a template file of the slide show, a music file mapping table for mapping a music file identifier of the music file to a slide show template file identifier of the template file of the slide show, an image file presenting unit for presenting the image file stored on the image file storage unit, an image file selection receiving unit for receiving the selection of the image file presented by the image file presenting unit, a music file presenting unit for presenting the music file stored on the music file storage unit, a music file selection receiving unit for receiving the selection of the music file presented by the music file presenting unit, and a slide show file generating unit for generating a slide show file based on the music file selected by the music file selection receiving unit, the template file of the slide show having the slide show template file identifier corresponding to the music file identifier of the music file, and the image file selected by the image file selection receiving unit. With this arrangement, the slide show file is generated by simply selecting the image file and the music file.

The music file mapping table may map the number of image files, selected by the image file selection receiving unit, to the music file identifier, and the music file presenting unit may present, in accordance with the music file mapping table, the music file corresponding to the number of image files selected by the image file selection receiving unit. In this way, the music file corresponding to the number selected image files is selected.

The music file mapping table may define a permissible range to the number of image files selected by the image file selection receiving unit. With the predetermined range of the number of selected image files, the music file is mapped to the image files.

The file mapping table may map the number of image files, selected by the image file selection receiving unit, to the music file identifier, and the music file presenting unit may cause the music file selection receiving unit to receive only the music file corresponding to the number of image files selected by the image file selection receiving unit. The music file responsive to the number of selected image files is thus selected.

The image control apparatus may further include a mapping information table generating unit for generating the mapping information table based on the image file for use in the selected slide show and the slide show file generated by the slide show file generating unit. Correction information of the slide show file is also created in the generation of slide show file when the image file is shifted in location.

The mapping information table generating unit may generate the mapping information table containing attribute information of the image file, and include a keyword receiving unit for receiving a keyword, and an image file searching unit for searching an image file corresponding to the attribute information containing the keyword, wherein the image file presenting unit presents the image file found in the search. The image file is thus searched for according to the keyword.

In accordance with another embodiment of the present invention, an image control apparatus includes an image file storage unit for storing an image file, an image file transfer unit for transferring the image file stored on the image file storage unit to another apparatus, a slide show file storage unit for storing a slide show file describing the content of a slide show through which each image file is reproduced successively in order, a movement designation receiving unit for receiving designation of a slide show file to be moved, a file moving unit for moving the slide show file in accordance with the designation, a mapping information table for mapping an image file identifier of the image file to be used in the slide show, a slide show file identifier of the slide show file of the slide show, and a transfer destination of the transferred image file, and a slide show file correcting unit for correcting, in accordance with the transfer destination, a reference location of an image file in the slide show file, the image file having an image file identifier corresponding to the slide show file identifier of the designated slide show file. The slide show file executing normally the slide show is thus generated even if the slide show file is moved.

The image control apparatus may further include a transfer command receiving unit for receiving a command to transfer the image file stored on the image file storage unit to the other apparatus, wherein the image file transfer unit transfers the image file stored on the image file storage unit to the other apparatus in response to the command from the transfer command receiving unit. The image file can be transferred in response to the user's intention.

The slide show file correcting unit may include a transfer destination acquisition unit for acquiring, in accordance with the mapping information table, the transfer destination of the image file corresponding to the slide show file designated by the movement designation receiving unit, and an image file reference location rewriting unit for rewriting, in accordance with the transfer destination, the reference location of the image file to be used in the slide show of the slide show file. The reference location of the image file in the slide show file is thus rewritten based on the image file identifier, the slide show file identifier, and the transfer destination of the image file.

The mapping information table may contain an address of the other apparatus as the transfer destination of the image file. Once the reference location of the image file is rewritten in the slide show file, the slide show is normally performed regardless of wherever the slide show file is moved.

In accordance with another embodiment of the present invention, an image control apparatus includes a master image file storage unit for storing a master image file, a representative image file storage unit for storing a representative image file of the master image file, a master image file transfer unit for transferring the master image file stored on the master image file storage unit to another apparatus, a slide show file storage unit for storing a slide show file that describes the content of a slide show through which each representative image file stored on the representative image file storage unit is reproduced successively in order, a movement designation receiving unit for receiving designation of the slide show file to be moved, a file moving unit for moving the slide show file in accordance with the designation, a mapping information table for mapping a representative image file identifier of the representative image file to be used in the slide show, a slide show file identifier of a slide show file corresponding to the slide show, a master image file identifier of the master image file corresponding to the representative image file, and a transfer destination of the transferred master image file, and a slide show file correcting unit for correcting the slide show file so that the file to be used in the slide show is changed from the representative image file to the master image file in accordance with the mapping information table. Even if the slide show file of a slide show of a thumbnail image is moved, a slide show file of a slide show of a mater image file is generated.

The image control apparatus may further include a transfer command receiving unit for receiving a command to transfer the master image file stored on the master image file storage unit to the other apparatus, wherein the master image file transfer unit transfers the master image file stored on the master image file storage unit to the other apparatus in response to the command from the transfer command receiving unit. The image file is transferred based on the user's intention.

In accordance with another embodiment of the present invention, one of a method and a program of an image control apparatus including an image file storage unit for storing an image file, a slide show file storage unit for storing a slide show file describing the content of a slide show through which each image file is reproduced successively in order, and a mapping information table for mapping an image file identifier of the image file to be used in the slide show to a slide show file identifier of the slide show file of the slide show, includes the steps of receiving the image file to be moved and designation of a movement destination of the image file, moving the image file to the movement destination in accordance with the designation, and correcting, in accordance with the movement destination, a reference location of the image file in the slide show file having the slide show file identifier corresponding to the image file identifier of the designated image file. Even if the image file is shifted in location, the slide show file executing the slide show is reproduced with no possibility of the image file missing.

In accordance with another embodiment of the present invention, one of a method and a program of an image control apparatus for transferring an image file stored on image file storage unit to an external apparatus as a transfer destination, including the image file storage unit for storing the image file, a slide show file storage unit for storing a slide show file describing the content of a slide show through which each image file is reproduced successively in order, and a mapping information table for mapping an image file identifier of the image file to be used in the slide show, a slide show file identifier of the slide show file of the slide show, and the transfer destination of the image file, includes the steps of transferring the image file stored on the image file storage unit to the external apparatus as the transfer destination and storing the transfer destination in the mapping information table, receiving designation of the slide show file to be moved, moving the slide show file in accordance with the designation, and correcting, in accordance with the transfer destination, a reference location of the image file in the slide show file, the image file having an image file identifier corresponding to the slide show file identifier of the designated slide show file. The slide show file executing normally the slide show is thus generated even if the slide show file is moved.

In accordance with another embodiment of the present invention, one of a method and a program of an image control apparatus for transferring a master image file stored on master image file storage unit to an external apparatus as a transfer destination, including the master image file storage unit for storing the master image file, representative image file storage unit for storing a representative image file of the master image file, slide show file storage unit for storing a slide show file that describes the content of a slide show through which each representative image file stored on the representative image file storage unit is reproduced successively in order, and a mapping information table for mapping a representative image file identifier of the representative image file to be used in the slide show, a slide show file identifier of the slide show file of the slide show, a master image file identifier of the master image file corresponding to the representative image file, and the transfer destination of the transferred master image file, includes the steps of transferring the master image file stored on the master image file storage unit to the other apparatus, receiving designation of the slide show file to be moved, moving the slide show file in accordance with the designation, and correcting the slide show file so that the file to be used in the slide show is changed from the representative image file to the master image file in accordance with the mapping information table. Even if the slide show file of the slide show of the thumbnail image is moved, the slide show file of the slide show of the mater image file is generated.

In accordance with embodiments of the present invention, even if the image file is shifted in location, the slide show file executing the slide show is reproduced with no possibility of the image file missing.

### BRIEF DESCRIPTION OF THE DRAWINGS

FIGS. 1A and 1B illustrate an image pickup system in accordance with one embodiment of the present invention;

FIG. 2 is a block diagram of an image pickup apparatus in accordance with one embodiment of the present invention;

FIG. 3 illustrates a correction function of a slide show file in accordance with one embodiment of the present invention;

FIG. 4 illustrates the structure of the slide show file in accordance with one embodiment of the present invention;

FIG. 5 illustrates an example of an SMIL file;

FIG. 6 illustrates a mapping information table in accordance with one embodiment of the present invention;

FIGS. 7A and 7B illustrate an example of display screen for moving an image file in the image pickup apparatus in accordance with one embodiment of the present invention;

FIG. 8 illustrates an image pickup apparatus in accordance with one embodiment of the present invention;

FIG. 9 illustrates a correction function of the slide show file in accordance with one embodiment of the present invention;

FIG. 10 illustrates a mapping information table in accordance with one embodiment of the present invention;

FIG. 11 illustrates mapping information tables composed of an image information file group as a set of files describing image information relating to image files;

FIG. 12 illustrates an internal structure of an attribute file in accordance with one embodiment of the present invention;

FIGS. 13A and 13B illustrate a display example of display screen for moving the slide show file in accordance with one embodiment of the present invention;

FIG. 14 illustrates a slide show file generation function in accordance with one embodiment of the present invention;

FIG. 15 illustrates a music file mapping table in accordance with one embodiment of the present invention;

FIGS. 16A and 16B illustrate a display screen of the image pickup apparatus for generating the slide show file in accordance with one embodiment of the present invention;

FIGS. 17A and 17B illustrate the slide show file generation process in which the selection of music files is limited;

FIG. 18 illustrates a slide show through which a slide show file is executed in accordance with one embodiment of the present invention;

FIG. 19 is a flowchart illustrating a process for correcting the slide show file in accordance with one embodiment of the present invention;

FIG. 20 is a flowchart illustrating a process for correcting the slide show file in accordance with one embodiment of the present invention; and

FIG. 21 is a flowchart illustrating a process for generating the slide show file in accordance with one embodiment of the present invention.

### DESCRIPTION OF THE PREFERRED EMBODIMENTS

The embodiments of the present invention are described below with reference to the drawings. In the discussion of the embodiments, an image pickup apparatus is described as one example of an image control apparatus.

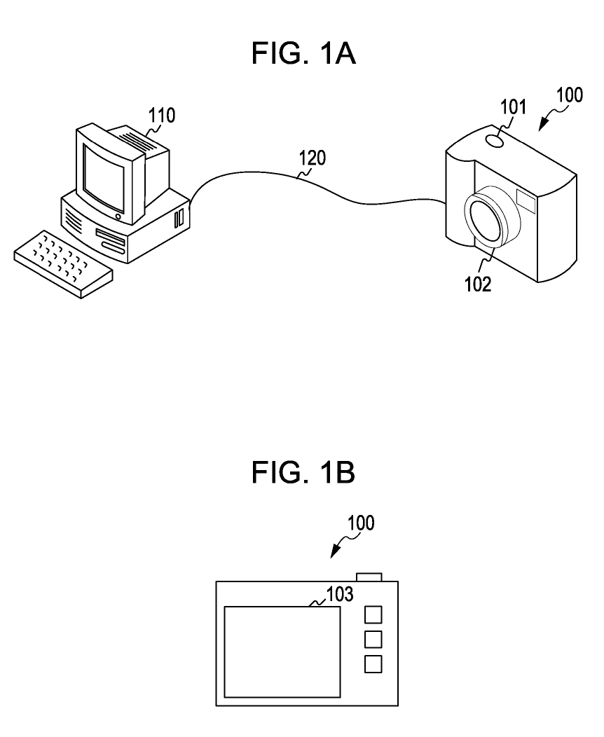

FIG. 1 illustrates an image pickup system in accordance with a first embodiment of the present invention. As shown in FIG. 1A, the image pickup system includes an image pickup apparatus 100 and an image display apparatus 110. When a shutter 101 of the image pickup apparatus 100 is pressed, an image file of an image captured through a lens unit 102 is generated and stored on the image pickup apparatus 100. The image file generated by the image pickup apparatus 100 may also be transferred to the image display apparatus 110 via cable 120. The image file may be transferred to the image display apparatus 110 in a wireless fashion without using the cable 120. The image file is then stored on the image display apparatus 110.

FIG. 1B is a rear view of the image pickup apparatus 100. A display 103 is arranged on the back of the image pickup apparatus 100. The display 103 includes but is not limited to a liquid-crystal display (LCD). The image file stored on the image pickup apparatus 100 may be displayed on the display 103.

In accordance with the first embodiment of the present invention, a slide show may be displayed on the display 103 of the image pickup apparatus 100 or the image display apparatus 110 based on a slide show file. The slide show file describes the content of a slide show, in which image files stored on the image pickup apparatus 100 are reproduced successively in order.

The slide show file method in accordance with the embodiments of the present invention is an external reference method in which reference information for referencing an image file for the slide show external to the slide show file and information relating to effects such transition in the slide show are described in the slide show file. In a self-contained slide show file method, as opposed to the external reference method, an image file forming a slide show and information relating to effects such as transition are described as a single moving image file.

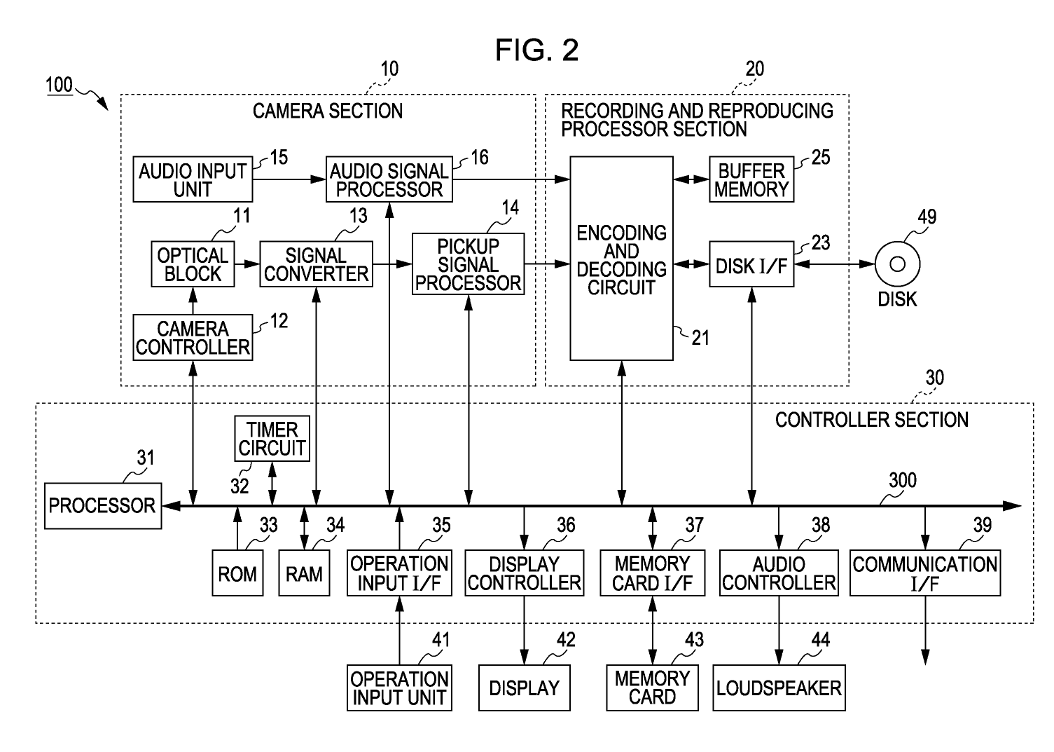

FIG. 2 is a block of the image pickup apparatus 100 in accordance with one embodiment of the present invention. The image pickup apparatus 100 includes a camera section 10, a reading and reproducing processor section 20, and a controller section 30.

The camera section 10 includes an optical block 11, a camera controller 12, a signal converter 13, a pickup signal processor 14, an audio input unit 15, and an audio signal processor 16. The optical block 11 includes a lens group for picking up an image of a subject, an aperture diaphragm mechanism, a focus adjustment mechanism, a zoom mechanism, a shutter mechanism, a flash mechanism, an image stabilizing mechanism, etc. The camera controller 12 generates a control signal to be supplied to the optical block 11 in response to a control signal from the controller section 30. The generated control signal is supplied to the optical block 11 to perform zoom control, shutter control, and exposure control.

The signal converter 13 is composed of an image pickup device such as charge-coupled device (CCD), and incident light, guided through the optical block 11, is focused to form an image on the focusing surface of the signal converter 13. Upon receiving an image capturing timing signal from the controller section 30 in response to a shutter operation, the signal converter 13 converts the image of the subject focused on the focusing surface into a pickup image signal, thereby supplying the pickup image signal to the pickup signal processor 14.

In accordance with a control signal from the controller section 30, the pickup signal processor 14 performs gamma correction and auto gain control (AGC) process on the pickup image signal while also converting the pickup image signal into a video signal as a digital signal. The audio input unit 15 picks up sound about the subject during image pickup. An audio signal from the audio input unit 15 is supplied to the audio signal processor 16. In response to a control signal from the controller section 30, the audio signal processor 16 performs correction and AGC process on the audio signal while converting the audio signal into a digital signal at the same time.

The reading and reproducing processor section 20 includes an encoding and decoding circuit 21, a disk interface (I/F) 23, and a buffer memory 25.

The encoding and decoding circuit 21 has an encoding function to encode the video signal and the audio signal from the camera section 10, and multiplex the encoded signals into compressed data. On the other hand, the encoding and decoding circuit 21 has a decoding function to separate the compressed data into a video signal and an audio signal, and decodes the separated signals. In response to a control signal from the controller section 30, the encoding and decoding circuit 21 performs auto white balance control, exposure correction control, and expansion control responsive to digital zoom magnification on the video signal from the pickup signal processor 14.

Upon receiving the compressed data from the encoding and decoding circuit 21, the disk I/F 23 writes the compressed data onto a disk 49. The disk I/F 23 also reads the compressed data from the disk 49, and supplies the read compressed data to the encoding and decoding circuit 21. The buffer memory 25, including synchronous dynamic random access memory (SDRAM), serves as a working memory area for the decoding and encoding functions of the encoding and decoding circuit 21.

The controller section 30 includes a processor 31, a read-only memory (ROM) 33, a random-access memory (RAM) 34, an operation input interface (I/F) 35 for connecting an operation input unit 41, a display controller 36 for connecting a display 42, a memory card interface (I/F) 37 for connecting a memory card 43, an audio controller 38 for connecting a loudspeaker 44, a communication interface (I/F) 39 for connecting a network, a timer circuit 32 for recording image pickup time, and a system bus 300 for interconnecting these elements.

The processor 31 generally controls the controller section 30, and uses the RAM 34 as the working memory area thereof. In accordance with the present embodiment, the RAM 34 stores a slide show file, a file mapping information table, a music information table, etc. The ROM 33 stores a program for controlling the camera section 10, and a program for executing recording control and playback control of the video signal and the audio signal.

The operation input unit 41 connected to the operation input I/F 35 includes a plurality of keys such as a mode switching key for switching between an image pickup mode and a playback mode, a zoom adjusting key, an exposure adjusting key, a shutter key, a moving image shooting key, a display adjusting key for the display 42, etc. The operation input I/F 35 transfers an operation signal from the operation input unit 41 to the processor 31. The processor 31 determines which key is operated on the operation input unit 41, and performs control process responsive to the determination result.

The display 42 connected to the display controller 36 may include an LCD, for example, and under the control of the processor 31, displays one of the video signal from the camera section 10 and the video signal read from the disk 49. The display 42 constitutes part of the function of the display 103 of FIG. 1.

The memory card I/F 37 writes the compressed data from the encoding and decoding circuit 21 onto the memory card 43. The memory card I/F 37 also reads the compressed data from the memory card 43 and supplies the read compressed data to the encoding and decoding circuit 21. The timer circuit 32 generates time information representing the year, the month, the day, the hour, the minute and the second.

Under the control of the processor 31, the loudspeaker 44 connected to the audio controller 38 reproduces one of the audio signal from the camera section 10 and the audio signal read from the disk 49.

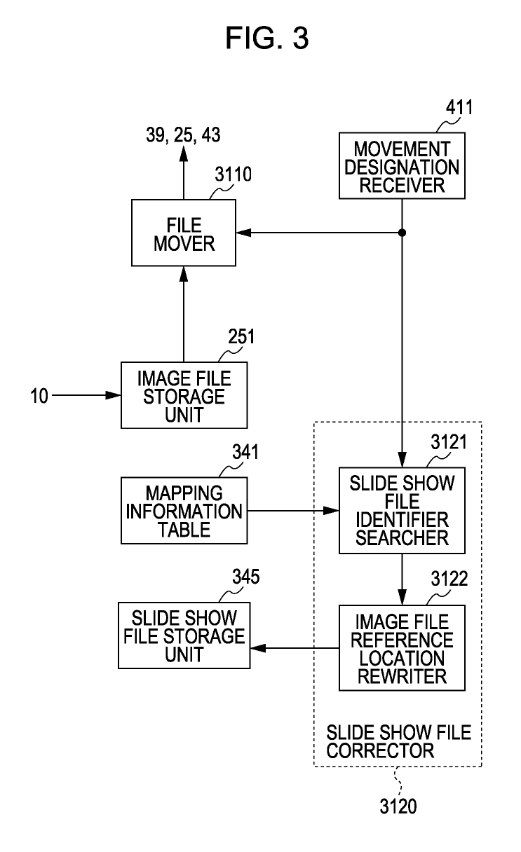

FIG. 3 illustrates the correction function of the slide show file in accordance with one embodiment of the present invention. The correction function of the slide show file includes as functional blocks a movement designation receiver 411, an image file storage unit 251 storing an image file supplied from the camera section 10, a file mover 3110, a mapping information table 341, a slide show file storage unit 345 storing the slide show file, and a slide show file corrector 3120.

The movement designation receiver 411 receives an image file to be moved and designation of a movement destination of the image file. Upon receiving the image file to be moved and the designation of the movement destination of the image file, the movement designation receiver 411 notifies the file mover 3110 and the slide show file corrector 3120 of an image file identifier of the image file to be moved and the movement destination of the image file.

The file mover 3110 moves the image file stored on the image file storage unit 251 in accordance with the image file identifier of the image file to be moved and the movement destination of the image received by the movement designation receiver 411.

The mapping information table 341 stores the image file identifier of the image file to be used in the slide show and a slide show file identifier of a slide show file with one identifier associated with the corresponding identifier.

The slide show file corrector 3120 corrects, in accordance with the movement destination of the image file, a reference location of the image file in the slide show file having the slide show file identifier corresponding to the image file identifier of the image file designated by the movement designation receiver 411. The slide show file corrector 3120 includes a slide show file identifier searcher 3121 and an image file reference location rewriter 3122.

The slide show file identifier searcher 3121 searches the mapping information table 341 for the slide show file identifier corresponding to the image file identifier of the image file supplied from the movement designation receiver 411. The slide show file identifier found by the slide show file identifier searcher 3121 is supplied to the image file reference location rewriter 3122.

The image file reference location rewriter 3122 rewrites, in accordance with the movement destination, the image file in the slide show file having the slide show file identifier supplied from the slide show file identifier searcher 3121.

The movement designation receiver 411 may be implemented by the operation input unit 41 and the operation input I/F 35, for example. The image file storage unit 251 may be implemented by the buffer memory 25. The file mover 3110 and the slide show file corrector 3120 may be implemented by the processor 31. The mapping information table 341 and the slide show file storage unit 345 for storing the slide show file may be implemented by the RAM 34.

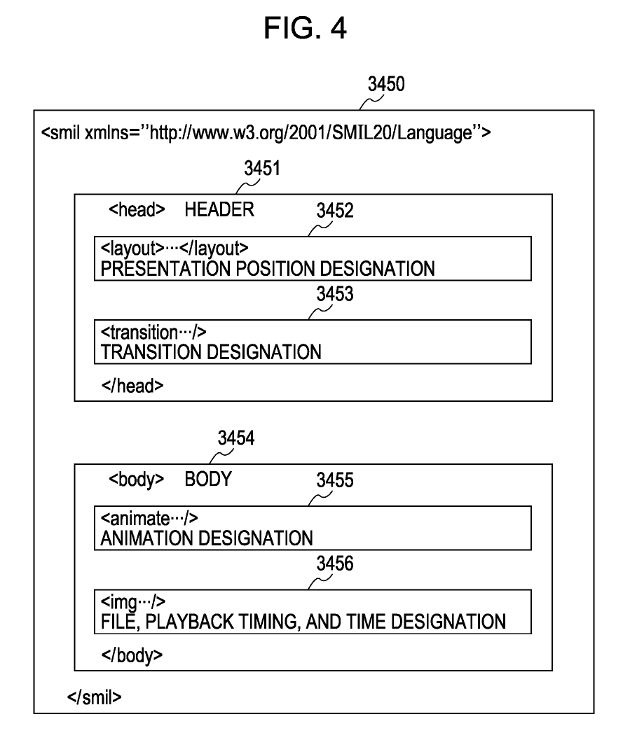

FIG. 4 illustrates one example of structure of the slide show file in accordance with one embodiment of the present invention. The slide show file is described using synchronized multimedia integration language (SMIL) herein, but the present invention is not limited to SMIL. SMIL is integrated multimedia standards proposed by W3C (World Wide Web Consortium), and is a language permitting multimedia presentation based on XML (extensible Markup Language).

A SMIL file 3450 includes, as major parts thereof, a header 3451 describing a display position of presentation and transition effects, and a body 3454 describing time control of the presentation. The SMIL file 3450 starts with <smil . . . > tag and ends with </smil> tag. The start tag includes xmlns attribute called name space. As shown in FIG. 4, <smil xmlns=“http:/www.w3.org/2001/SMIL20/Language”> means that the file is written in SMIL2.0 markup language.

In the header 3451, presentation position designation 3452 and transition designation 3453 are performed, and these designations are described between a <head> tag and a </head> tag.

The presentation position designation 3452 designates a display position for displaying the image file and the like, and is described between a <layout> tag and a </layout> tag. The transition designation 3453 designates the effect when the image files are switched one after another in the slide show, and is described in “ . . . ” in a <transition . . . /> tag.

In the body 3454, animation designation 3455 and file, playback timing, and time designation 3456 are performed, and are described between a <body> tag and a </body> tag.

The animation designation 3455 designates an animation of the image file, and is described in “ . . . ” of a <animate . . . /> tag. The file, playback timing, and time designation 3456 designates a reference location of an image file and a music file for the slide show, and timing of the playback of the image file and the music file. The designation of the reference location of the image file is described in “ . . . ” of a <img . . . /> tag.

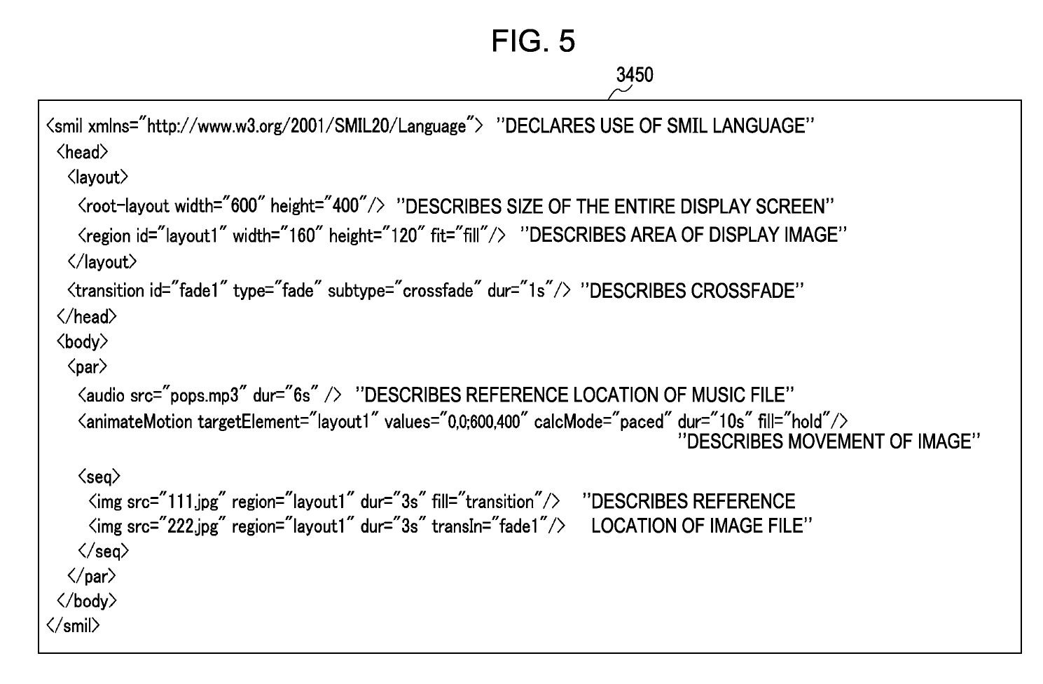

FIG. 5 illustrates a SMIL file 3450. In the SMIL file 3450, first line <smil xmlns=“http://www.w3.org/2001/SMIL20/Language”> states that the following description complies with SMIL2.0. The statement <root-layout width=“600” height=“400”/> describes the size of the entire screen for displaying the slide show. As shown in FIG. 5, the screen for displaying the slide show has a size of width of 600 and height of 400. The statement <region id=“layout1” width=“160” height=“120” fit=“fill”/> describes a region where the image file is displayed. As shown in FIG. 5, the region for displaying the image file has a size of width of 160 and height of 120. The above statements correspond to the presentation position designation 3452 of the header 3451 of FIG. 4.

The statement <transition id=“fade1” type=“fade” subtype=“crossfade” dur=“1s”/> specifies crossfade as transition effect. The crossfade means that one image fades out while another image fades in at the same time. The designation of crossfade corresponds to the transition designation 3453 of the header 3451 of FIG. 4.

The statement <audio src=“pops.mps3” dur=“6s”/> describes the reference location of the music file to be inserted into the slide show. One line below, in <seq>, the statements rimg src=“111.jpg” region=“layout1” dur=“3s” fill=“transition”/> and rimg src=“222.jpg” region=“layout1” dur=“3s” transIn=“fade1”/> describe the reference location of the image file to be used in the slide show and order of playback images. These statements correspond to the file, playback timing, and time designation 3456 of the body 3454 of FIG. 4.

The statement <animateMotion targetElement=“layout1” values=“0,0; 600,400” calcMode=“paced” dur=“10s” fill=“hold”/> describes the movement mode of the image file. This statement corresponds to the animation designation 3455 of the body 3454 of FIG. 4.

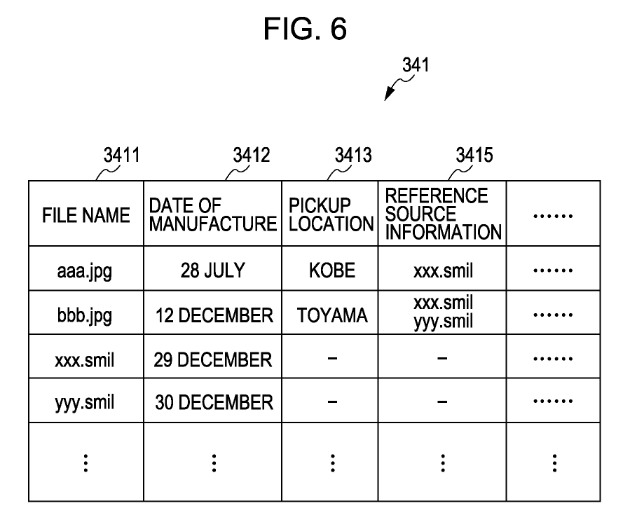

FIG. 6 illustrates an example of the mapping information table 341 in accordance with one embodiment of the present invention. The mapping information table 341 contains a file name 3411 of each of the image file and the slide show file, date of manufacture 3412 indicating the date of manufacture of the image file and the slide show file, image pickup position 3413 indicating the image pickup position of the image file, and reference source information 3415. User input information (not shown in FIG. 6) input by a user and associated with the image file may be contained with the file name 3411 associated therewith.

The reference source information 3415 contains a file name of the slide show file of the slide show using the image file corresponding to the file name. Information regarding the slide show file may be added to each of the file name 3411 and the date of manufacture 3412.

When the image file is moved, the slide show file of the slide show using the image file is searched in the mapping information table 341. For example, if the file name of the image file to be moved is “aaa.jpg,” the file name of the slide show file of the slide show using that image file is “xxx.smil.” If the image file having the file name “aaa.jpg” is moved, the reference location of the image file “aaa.jpg” in the slide show file having the file name “xxx.smil” is to be corrected.

If the file name of the image file to be moved is “bbb.jpg,” the file name of the slide show file of the slide show using that image file is “xxx.smil” and “yyy.smil.” In this case, the reference location of the image file “bbb.jpg” in the slide show files having the file names “xxx.smil” and “yyy.smil” is corrected.

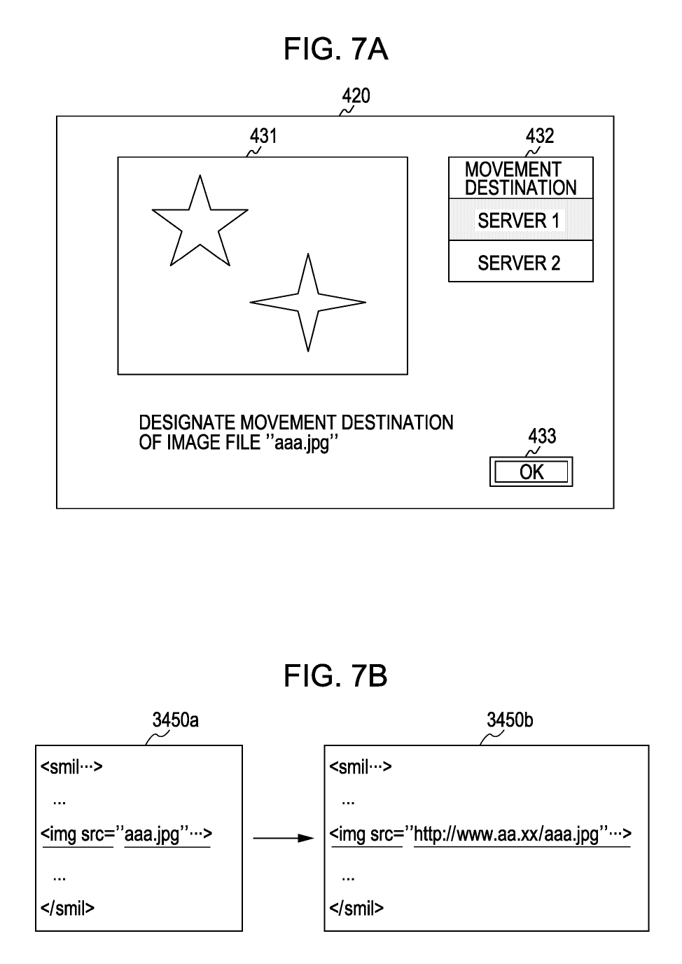

FIGS. 7A and 7B illustrate an example of display screen of the image pickup apparatus 100 for moving the image file in accordance with one embodiment of the present invention. FIG. 7A illustrates a display screen 420 that appears after the image file to be moved is selected on an image file selection screen (not shown). The display screen 420 includes an image file display 431 to be moved and selected on the image file selection screen (not shown), a movement destination display 432, and an OK button 433.

To move the image file, the OK button 433 is selected after one of a “server 1” and a “server 2” on the movement destination display 432 is selected as the movement destination of the image file. In this way, the image file to be moved and selected on the image file selection screen (not shown) is moved to one of the “server 1” and the “server 2.”

FIG. 7B illustrates how the reference location of the image file in the slide show file is corrected when the image file is moved in FIG. 7A. In a slide show file 3450a prior to the movement of the image file, the reference location of the image file for the slide show is rimg src=“aaa.jpg”>. In a slide show file 3450b subsequent to the movement of the image file, the reference location of the image file for the slide show is corrected to be rimg src=“http://www.aa.xx/aaa.jpg”>.

In the slide show file 3450b, the image file moved to the “server 1” is referenced in accordance with a uniform resource locator (URL) as an address indicating the position of the “server 1”, namely, the URL “http://www.aa.xx/” of the “server 1.”

The image file is moved to an external apparatus such as the server 1 connected to the image pickup apparatus 100 in accordance with the present embodiment. The present invention is not limited to such a case. For example, the reference location of the image file in the slide show file is corrected based on the movement destination even when the image file is moved within the image pickup apparatus 100.

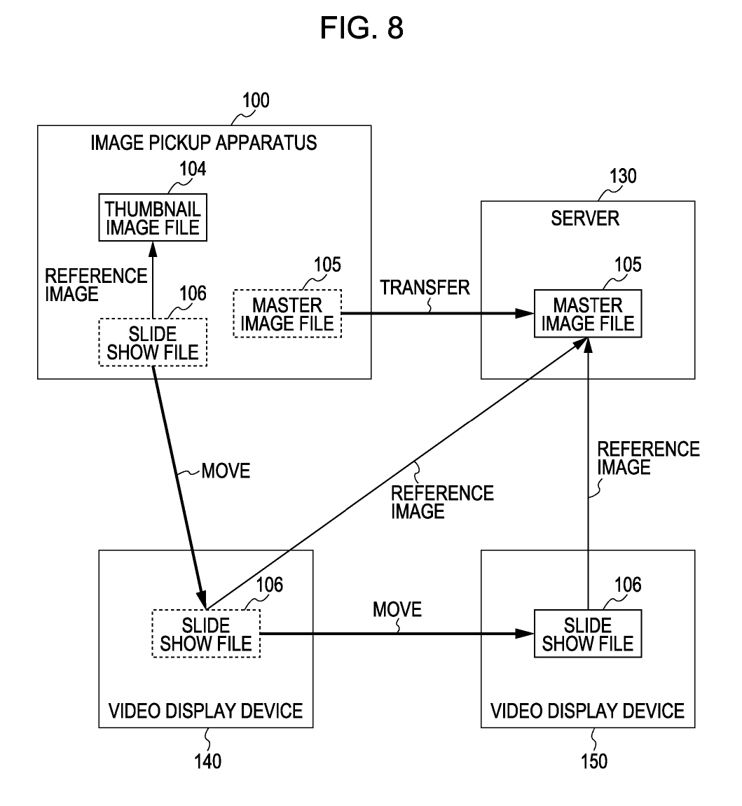

FIG. 8 illustrates an image pickup system in accordance with another embodiment of the present invention. Based on a master image file 105 picked up by the image pickup apparatus 100, a thumbnail image file 104 as a representative image of the master image file 105 is generated. The image file to be used in the slide show is the thumbnail image file 104. Alternatively, the image file may be the master image file 105. In the context of this embodiment, an image file serving as a source for an thumbnail image file is referred to as “master image file.” Two types of files as image files, namely, the master image file and the thumbnail image file are thus present.

When a slide show file 106 generated in the image pickup apparatus 100 is stored in the image pickup apparatus 100, the slide show is performed by reproducing successively in order the thumbnail image files 104.

In accordance with this embodiment, the master image file 105 picked up by the image pickup apparatus 100 may be transferred to a server 130 for storage there. By transferring a large sized image file to the server, the memory in the image pickup apparatus 100 may be efficiently used. The master image file 105 picked up by the image pickup apparatus 100 may be automatically transferred when the image pickup apparatus 100 is connected to the server 130 or may be transferred in response to an operation by a user.

If a slide show file 106 stored on the image pickup apparatus 100 is moved to a video display device 140 such as a personal computer, an image file referenced by the slide show file 106 is modified from a thumbnail image file to an master image file. A memory size in the video display device 140 such as a personal computer is typically larger than that in the image pickup apparatus 100. The video display device 140 also outperforms the image pickup apparatus 100 in processing capability of the image file. If the master image file is processed in the slide show, the video display device 140 is expected to work in a manner free from any problem in terms of processing capability.

When the image file referenced by the slide show file 106 is changed from the thumbnail image file to the master image file, the URL may serve as an address indicating the position of the master image file. If the slide show file 106 is further moved from the video display device 140 to a video display device 150, the video display device 150 executes the slide show file 106 without the need for modifying the reference location of the master image file in the slide show file. The address indicating the position of the master image file may be other than the URL.

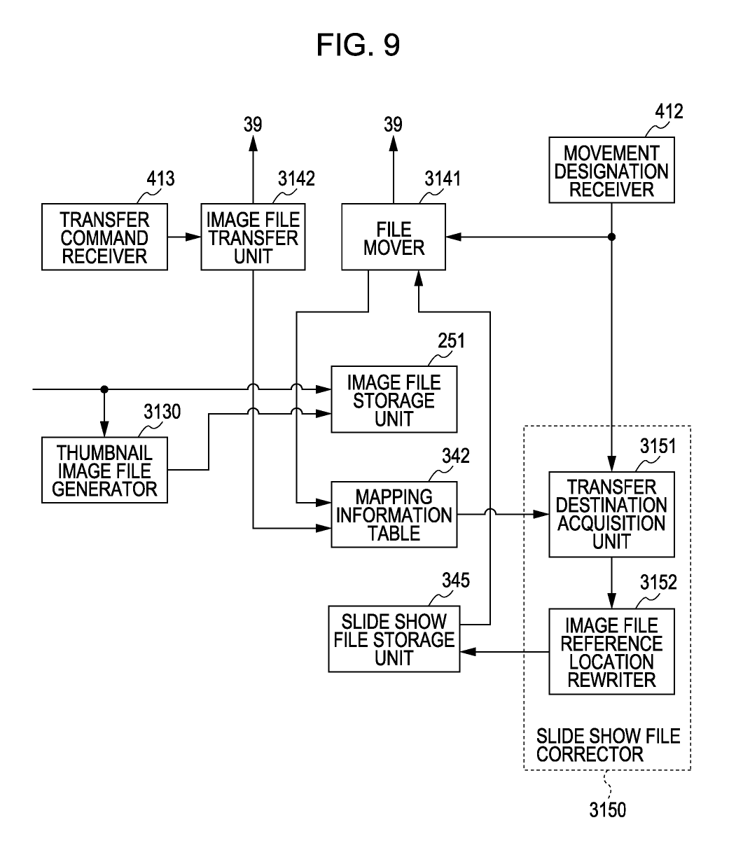

FIG. 9 illustrates the correction function of the slide show file in accordance with one embodiment of the present invention. The correction function of the slide show file includes a thumbnail image file generator 3130, an image file storage unit 251, a movement designation receiver 412, a file mover 3141, a slide show file storage unit 345 for storing the slide show file, an image file transfer unit 3142, a transfer command receiver 413, a mapping information table 342, and a slide show file corrector 3150.

The thumbnail image file generator 3130 generates a thumbnail image file based on a master image file supplied from the camera section 10. The thumbnail image file generated on the thumbnail image file generator 3130 is stored on the image file storage unit 251. The image file storage unit 251 stores the master image file supplied from the camera section 10 and the thumbnail image file generated by the thumbnail image file generator 3130. The thumbnail image file 104 and the master image file 105, shown in FIG. 8, correspond to the thumbnail image file and the master image file stored on the image file storage unit 251.

The movement designation receiver 412 receives a slide show file to be moved and designation of a movement destination of the slide show file. Upon receiving the slide show file to be moved and the designation of the movement destination, the movement designation receiver 412 notifies the file mover 3141 and the slide show file corrector 3150 of a slide show file identifier of the slide show file to be moved and the movement destination of the slide show file.

The file mover 3141 moves the image file, stored on the slide show file storage unit 345, in accordance with the slide show file identifier of the slide show file to be moved and the movement destination of the slide show file supplied from the movement designation receiver 412.

The image file transfer unit 3142 transfers the master image file stored on the image file storage unit 251 to an external apparatus. The transfer command receiver 413 receives a command for the image file transfer unit 3142 to transfer the master image file to the external apparatus. In response to the command received by the transfer command receiver 413, the image file transfer unit 3142 transfers the master image file to the external apparatus. Without any command from the outside, the image file transfer unit 3142 may transfer the master image file to the external apparatus. In this case, the transfer command receiver 413 may be eliminated.

The mapping information table 342 maps, in storage with one in association with another, an image file identifier of the master image file to be used in the slide show, an image file identifier of the thumbnail image file, a slide show file identifier of the slide show file, and a transfer destination of the transferred master image file. The image file transfer unit 3142 writes the transfer destination of the transferred image file onto the mapping information table.

The slide show file corrector 3150 corrects the reference location of the image file in the slide show file designated by the movement designation receiver 412. In accordance with another embodiment of the present invention, the thumbnail image file is assumed as the image file to be used in the slide show if the slide show file is present in the image pickup apparatus 100. If the slide show file is moved to an external apparatus, the master image file is assumed as an image file to be used in the slide show. The slide show file corrector 3150 corrects the reference location of the thumbnail image file in the slide show file to the reference location of the master image file.

The slide show file corrector 3150 includes a transfer destination acquisition unit 3151 and an image file reference location rewriter 3152. In accordance with the mapping information table, the transfer destination acquisition unit 3151 acquires the transfer destination of the master image file corresponding to the slide show file designated by the movement designation receiver 412. The image file reference location rewriter 3152 rewrites the reference location of the master image file to be used in the slide show of the slide show file, in accordance with the transfer destination acquired by the transfer destination acquisition unit 3151.

The thumbnail image file generator 3130, the file mover 3141, the image file transfer unit 3142, and the slide show file corrector 3150 may be mainly implemented by the processor 31, for example. The image file storage unit 251 may be implemented by the buffer memory 25. The movement designation receiver 412 and the transfer command receiver 413 may be implemented by the operation input unit 41 and the operation input I/F 35. The slide show file storage unit 345 and the mapping information table 342 may be implemented by the RAM 34.

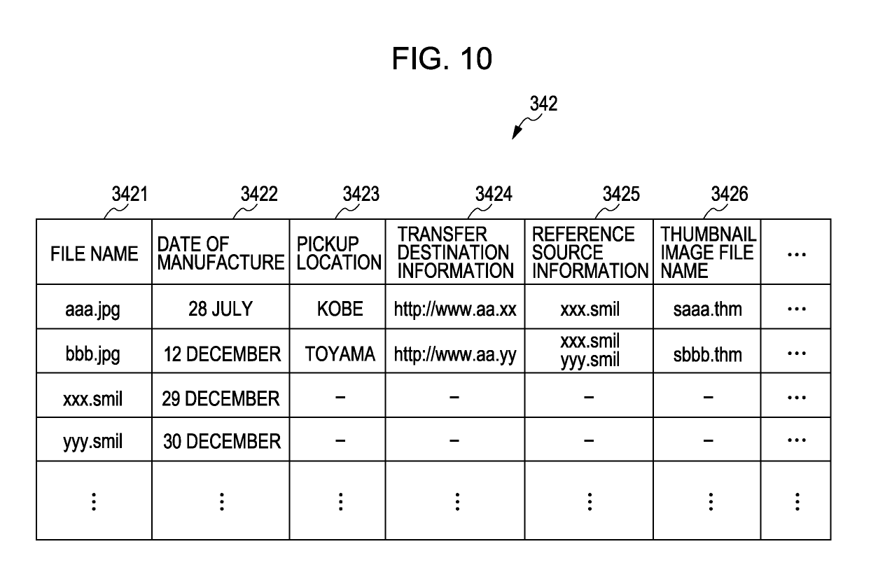

FIG. 10 illustrates a mapping information table in accordance with the embodiment of FIG. 8. The mapping information table 342 contains a file name 3421 of each of the master image file and the slide show file, date of manufacture 3422 indicating the date of manufacture of the master image file and the slide show file, pickup location 3423 indicating the pickup position of the master image file, transfer destination information 3424 indicating the transfer destination of the transferred master image file, reference source information 3425, and thumbnail image file name 3426 of the thumbnail image file corresponding to the master image file. User input information (not shown in FIG. 10), input by a user and imparted to the image file, may be stored in association with the file name 3421.

In this embodiment, the thumbnail image file is assumed as an image file to be used in the slide show if the slide show file is present in the image pickup apparatus 100. The reference source information 3425 indicates the slide show file that handles in the slide show the thumbnail image file having the thumbnail image file name 3426. Information regarding the slide show file may be added to each of the file name 3421 and the date of manufacture 3422.

When the slide show file is transferred to an external apparatus, the master image file 105 is referenced as the image file to be used in the slide show. When the slide show file is transferred to the external apparatus, the thumbnail image file name 3426 referenced by the slide show file is searched for. The master image file corresponding to the found thumbnail image file name is an image file to be referenced in the slide show file. The reference location of the image file in the slide show file is corrected in accordance with the transfer destination information 3424.

The use of the mapping information table 342 with a slide show file “xxx.smil” transferred to an external apparatus in accordance with one embodiment of the present invention is described below.

When the slide show file “xxx.smil” is transferred to the external apparatus, reference image files of the slide show file “xxx.smil” are thumbnail image files “saaa.thm” and “sbbb.thm.” Master image files for the thumbnail image files “saaa.thm” and “sbbb.thm” are master image files “aaa.jpg” and “bbb.jpg.”

The image file reference locations in the slide show file “xxx.smil” are corrected based on the transfer destination of the master image files “aaa.jpg” and “bbb.jpg” described in the transfer destination information 3424. The image file reference location for the master image file “aaa.jpg” is “http://www.aa.xx/aaa.jpg”, and the image file reference location for the master image file “bbb.jpg” is “http://www.bb.xx/bbb.jpg.”

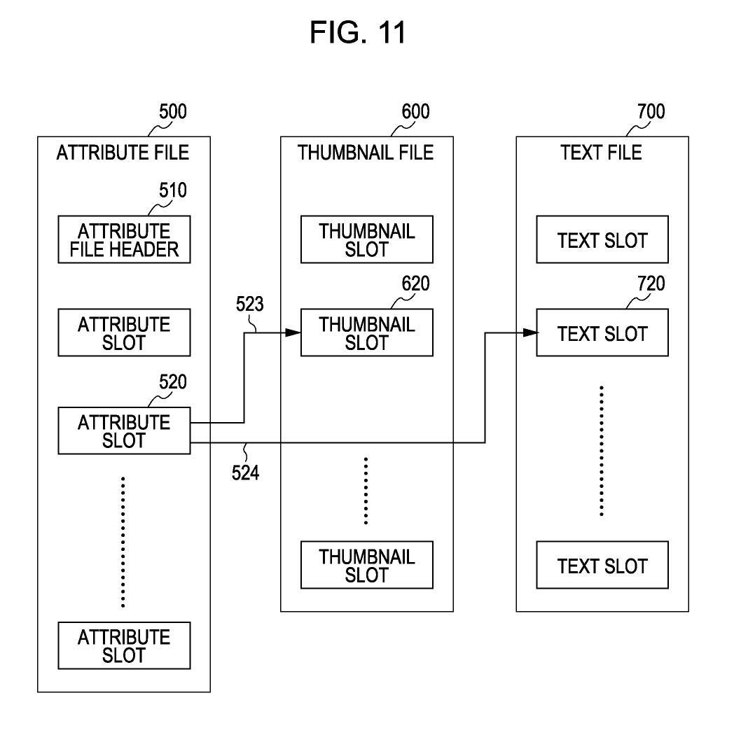

FIG. 11 illustrates mapping information tables 341 and 342 in accordance with one embodiment of the present invention. The mapping information tables 341 and 342 are composed of an image information file group as a set of files of image information relating to the image file.

The image information file group is a set of files containing the image information of the image file. The image information file group includes an attribute file 500, a thumbnail 600, and a text file 700. The attribute file 500 includes one attribute file header 510 and at least one attribute slot 520. Each attribute slot 520 has a fixed length in the attribute file 500. The internal structure of the attribute file 500 will be described later.

The thumbnail 600 includes at least one thumbnail slot 620. The thumbnail slot 620 contains information relating to a thumbnail image file generated based on an image file. Each thumbnail slot 620 has a fixed length in the thumbnail 600. Each thumbnail slot 620 is tagged with an index number indicating the order thereof from the head of the thumbnail 600.

The text file 700 includes at least one text slot 720. Each text slot 720 contains text information relating to the image file. The text information is any character string input by the user, and for example, contains a pickup position or a title of the image file. Each text slot 720 has a fixed length in the text file 700. Each text slot 720 is tagged with an index number indicating the order thereof from the head of the text file 700.

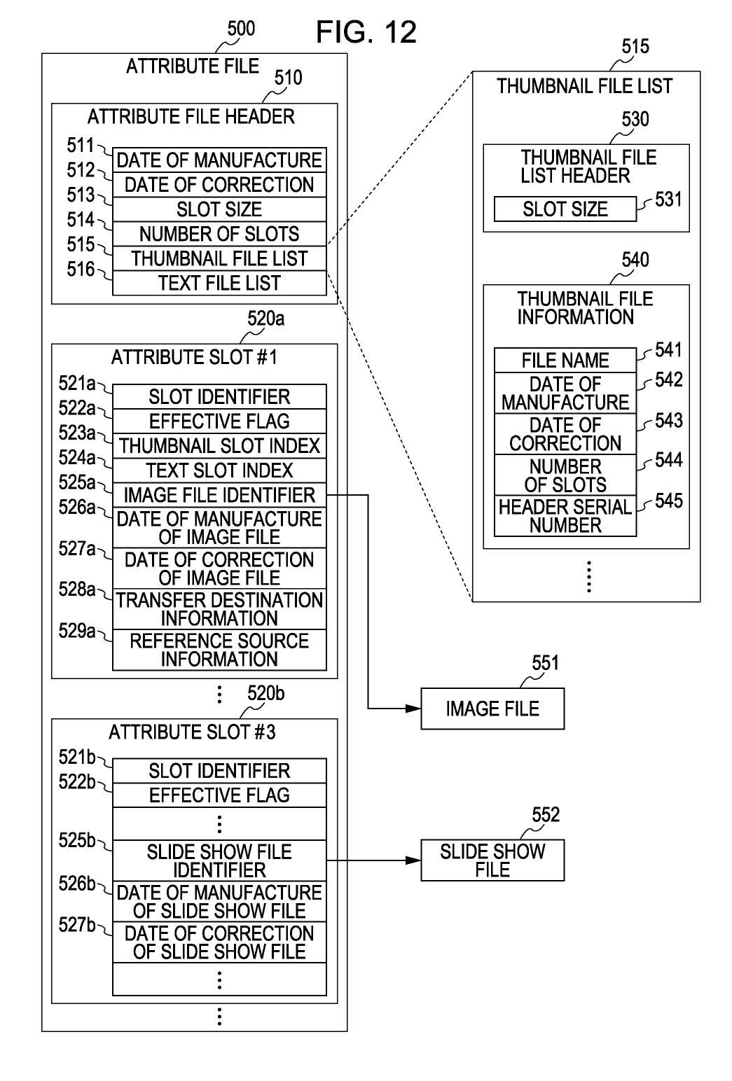

FIG. 12 illustrates the internal structure of the attribute file 500 in accordance with one embodiment of the present invention. The attribute file header 510 in the attribute file 500 includes date of manufacture 511, date of correction 512, slot size 513, number of slots 514, thumbnail file list 515, and text file list 516.

The date of manufacture 511 indicates the date of manufacture on which the attribute file 500 was first manufactured. The date of correction 512 indicates the date of correction on which the attribute file 500 was corrected last. The slot size 513 indicates the capacity of each attribute slot 520 in the attribute file 500. Each attribute slot 520 has a fixed length in the attribute file 500. The number of slots 514 indicates the number of attribute slots 520 contained in the attribute file 500.

The thumbnail file list 515 and the text file list 516 contain information regarding the thumbnail 600 and information regarding the text file 700, respectively. For example, the thumbnail file list 515 includes one thumbnail file list header 530 and one unit of thumbnail file information 540. The thumbnail file list header 530 includes slot size 531 indicating the capacity of each thumbnail slot 620 in the thumbnail 600. As previously discussed, each thumbnail slot 620 has a fixed length in the thumbnail 600.

The thumbnail file information 540 includes a file name 541, date of manufacture 542, date of correction 543, number of slots 544, and header serial number 545. The file name 541 indicates a file name of the thumbnail 600. The date of manufacture 542 indicates the date of manufacture on which the thumbnail 600 was first produced. The date of correction 543 indicates the date of correction on which the thumbnail 600 was corrected last. The number of slots 544 indicates the number of thumbnail slots 620 contained in the thumbnail 600.

The thumbnail file list 515 has been discussed herein. Similarly, the text file list 516 also contains information regarding the text file 700.

An attribute slot 520a, regarding the image file, includes a slot identifier 521a, an effective flag 522a, a thumbnail slot index 523a, a text slot index 524a, an image file identifier 525a, date of manufacture of the image file 526a, date of correction of the image file 527a, transfer destination information 528a, and reference source information 529a.

The slot identifier 521a uniquely identifies the attribute slot 520a, and is used to associate different attribute slots with each other. For example, since the thumbnail slot 620 has a fixed length, it can happen that a single thumbnail is not accommodated in a single thumbnail slot 620. In such a case, the a plurality of attribute slots 520 are associated with each other using the slot identifiers 521a, and a single thumbnail is accommodated across the plurality of thumbnail slots 620. Since such an association process tends to become complex, the capacity of the thumbnail slot 620 is preferably set taking into consideration the size of the thumbnail.

The effective flag 522a indicates whether the content of the attribute slot 520a is valid or not. The thumbnail slot index 523a is an index number indicating the corresponding text slot 720. The image file identifier 525a is link information indicating the corresponding image file. An image file 551 corresponding to the image file identifier 525a can be accessed by referencing the image file identifier 525a contained in the attribute slot 520a. The date of manufacture of the image file 526a indicates the date of manufacture on which the corresponding image file was first manufactured. The date of correction of the image file 527a indicates the date of correction on which the corresponding image file was corrected last.

The transfer destination information 528a is position information of the transfer destination of the corresponding image file. The position information of the transfer destination is an address such as a URL, for example. The reference source information 529a is an identifier of the slide show file of the slide show of the corresponding image file.

An attribute slot 520b, relating to the slide show file, includes a slot identifier 521b, an effective flag 522b, a slide show file identifier 525b, date of manufacture of the slide show file 526b, and date of correction of the slide show file 527b.

Since the slot identifier 521b and the effective flag 522b are respectively similar to the slot identifier 521a and the effective flag 522a, the discussion thereof is omitted herein. The slide show file identifier 525b is link information indicating the corresponding slide show file. A slide show file 552 corresponding to the slide show file identifier 525b can be accessed by referencing the slide show file identifier 525b contained in the attribute slot 520b. The date of manufacture of the slide show file 526b indicates the date of manufacture on which the corresponding slide show file was manufactured first. The date of correction of the slide show file 527b indicates the date of correction on which the corresponding slide show file was corrected last.

If the mapping information table 341 is compared with the image information file group, the file name 3411 corresponds to each of the image file identifier 525a in the attribute slot 520a and the slide show file identifier 525b in the attribute slot 520b. The date of manufacture 3412 corresponds to each of the date of manufacture of the image file 526a in the attribute slot 520a and the date of manufacture of the slide show file 526b in the attribute slot 520b. Information corresponding to the image pickup position 3413 is described in the text slot 720 in the text slot index 524a in the attribute slot 520a. The reference source information 3415 corresponds to the reference source information 529a in the attribute slot 520a.

If the mapping information table 342 is compared with the image information file group, the file name 3421 corresponds to each of the image file identifier 525a in the attribute slot 520a and the slide show file identifier 525b in the attribute slot 520b. The date of manufacture 3422 corresponds to each of the date of manufacture of the image file 526a in the attribute slot 520a and the date of manufacture of the slide show file 526b in the attribute slot 520b. Information corresponding to the pickup position 3423 is described in the text slot 720 in the text slot index 524a in the attribute slot 520a. The transfer destination information 3424 corresponds to the transfer destination information 528a in the attribute slot 520a. The reference source information 3425 corresponds to the reference source information 529a in the attribute slot 520a. The thumbnail image file name 3426 is described in the thumbnail slot 620 in the thumbnail slot index 523a in the attribute slot 520a.

The image file, the thumbnail image file and slide show file are quickly accessed using the image information file group of FIGS. 11 and 12.

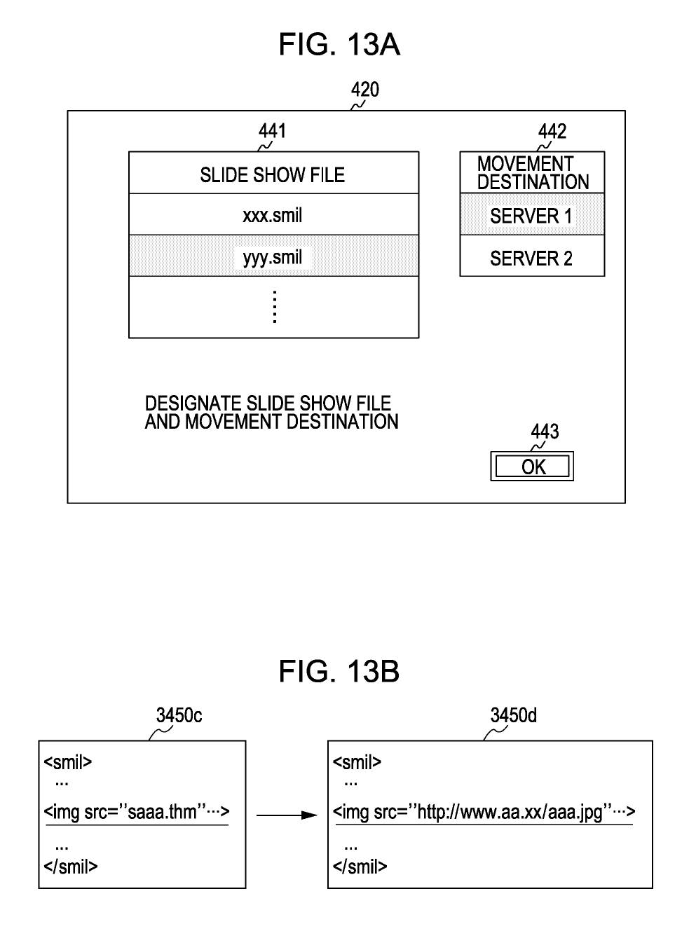

FIGS. 13A and 13B illustrate a display screen for moving a slide show file in accordance with one embodiment of the present invention. A display screen 420 of FIG. 7A includes a slide show file display 441, a movement destination display 442, and an OK button 443. The slide show file screen 441 is used to select a slide show file to be moved. The movement destination screen 442 is used to select the movement destination of the slide show file to be moved.

A desired slide show file is selected from file names “xxx.smil” and “yyy,smil” of the slide show files displayed on the slide show file display 441. The movement destination of the selected slide show file is selected on the movement destination display 442. When the OK button 443 is then selected, the selected slide show file is moved to the movement destination.

FIG. 13B illustrates how the reference location of the image file of the slide show file is corrected when the slide show file is moved in FIG. 13A. The master image file having the file name “aaa.jpg” in the present embodiment is present in the server having the URL “http://www.aa.xx/.”

When a slide show file 3450c having a file name “yyy.smil” is moved to the server 1 as shown in FIG. 13A, a thumbnail image file “saaa.thm” referenced prior to the movement is corrected to a thumbnail image file “aaa.jpg.” Since the reference location of the thumbnail image file becomes “http://www.aa.xx/aaa.jpg”, rimg src=“saaa.thm” . . . > in the slide show file 3450c is modified to be rimg src=“http://www.aa.xx/aaa.jpg” . . . >” in the slide show file 3450d.

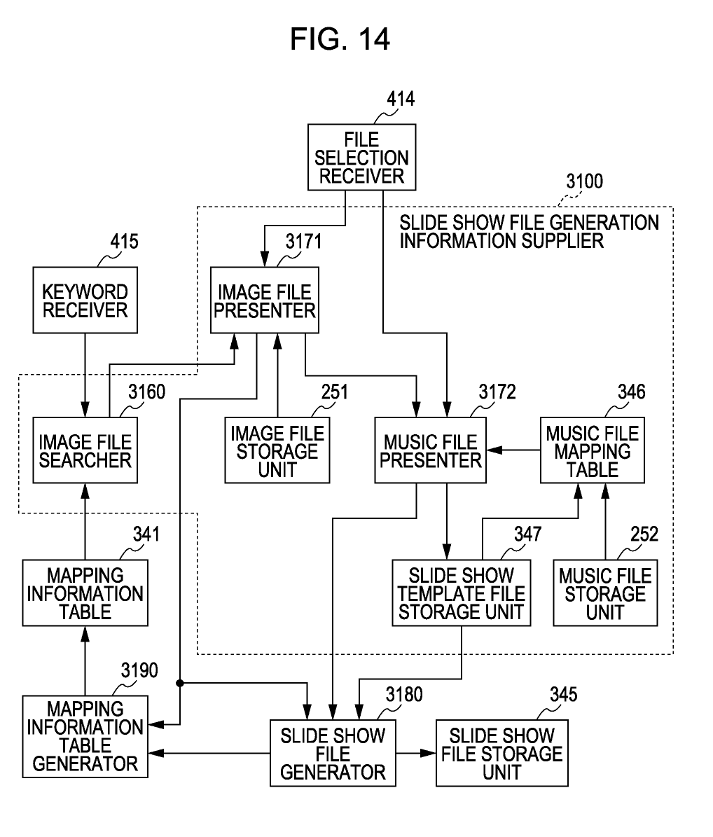

FIG. 14 illustrates a slide show file generating function in accordance with one embodiment of the present invention. The slide show file is generated based on an image file stored on an image file storage unit 251, a music file stored on a music file storage unit 252, and a slide show template file as a template of the slide show file stored on a slide show template file storage unit 347.

The slide show file generating function includes a file selection receiver 414, an image file presenter 3171, a keyword receiver 415, a slide show file generation information supplier 3100, a slide show file generator 3180, and a mapping information table generator 3190.

The slide show file generation information supplier 3100 supplies information required to generate the slide show file, and includes an image file searcher 3160, a music file mapping table 346, a music file presenter 3172, the image file storage unit 251, the music file storage unit 252 for storing a music file, a slide show template file storage unit 347 storing a slide show template file, and a mapping information table 341.

The file selection receiver 414 receives selection between information relating to the image file presented by the image file presenter 3171 and information relating to the music file presented by the music file presenter 3172.

The image file presenter 3171 acquires information relating to the image file from one of the image file storage unit 251 and the image file searcher 3160, and presents the acquired information relating to the image file. The information relating to the presented image file is selected by the file selection receiver 414. The image file presenter 3171 supplies the information relating to the selected image file to the music file presenter 3172 and the slide show file generator 3180.

The keyword receiver 415 receives a keyword for use in searching the image files. The image file searcher 3160 searches the mapping information table 341 for information relating to the image file having attribute information relating to the keyword received by the keyword receiver 415. The attribute information includes, but is not limited to, the date of manufacture of the image file, image pickup information, such as image pickup position, recorded during pickup, and user input information attached to the image file by the user. In accordance with the present embodiment, the image file can be searched for according to the attribute information incidental to the image file, and the user can easily access a desired image file. As shown in FIG. 14, the mapping information table is the mapping information table 341 of FIG. 3, but alternatively, may be the mapping information table 342 of FIG. 9.

The music file mapping table 346 contains a music file identifier of the music file stored on the music file storage unit 252, and a slide show file identifier of the slide show template file with one identifier in association with the other identifier. The music file mapping table 346 also contains the number of image files and the music file identifier with one in association with the other. The music file mapping table 346 may contain a permissible range to the number of selected image files.

The music file presenter 3172 acquires information relating to the music file from the music file mapping table 346, and presents the information relating to the acquired music file. The music file presenter 3172 presents all information regarding the music file contained in the music file mapping table 346. As previously discussed, the information relating to the music file is selected by the file selection receiver 414, and the music file presenter 3172 supplies the information relating to the selected music file to the slide show file generator 3180. The music file presenter 3172 also commands the slide show template file storage unit 347 to output to the slide show file generator 3180 the slide show template file corresponding to the music file selected by the file selection receiver 414 from the music file mapping table 346.

The music file presenter 3172 determines whether the number of image files selected by the file selection receiver 414 falls within the permissible number range corresponding to the music file selected by the file selection receiver 414. If it is determined that the number of image files selected by the file selection receiver 414 fails to fall within the permissible number range corresponding to the music file selected by the file selection receiver 414, the music file presenter 3172 denies the selection of the music file received by the file selection receiver 414.

If it is determined that the number of image files selected by the file selection receiver 414 falls within the permissible number range corresponding to the music file selected by the file selection receiver 414, the music file presenter 3172 commands the music file storage unit 252 and the slide show template file storage unit 347 to supply to the slide show file generator 3180 the music file selected by the file selection receiver 414 and the slide show template file corresponding to the music file.

In another embodiment of the present invention, the music file presenter 3172 may present only the music file corresponding to the number of image files, the selection of which is received by the file selection receiver 414.

The slide show file generator 3180 generates the slide show file in the external reference method described in FIG. 1, based on the information regarding the image file presented by the image file presenter 3171, the information regarding the music file presented by the music file presenter 3172, and the slide show template file supplied from the slide show template file storage unit 347. The slide show file generated by the slide show file generator 3180 is stored on the slide show file storage unit 345.

The mapping information table generator 3190 generates information to be contained in the mapping information table based on the information regarding the image file supplied from the image file presenter 3171 and the slide show file supplied from the slide show file generator 3180.

The file selection receiver 414 and the keyword receiver 415 may be implemented by the operation input unit 41 and the operation input I/F 35. The image file presenter 3171, the music file presenter 3172, the image file searcher 3160, the slide show file generator 3180, and the mapping information table generator 3190 may be implemented by the processor 31. The music file mapping table 346, the slide show template file storage unit 347 and the mapping information table 341 may be implemented by the RAM 34. The image file storage unit 251 and the music file storage unit 252 may be implemented by the buffer memory 25.

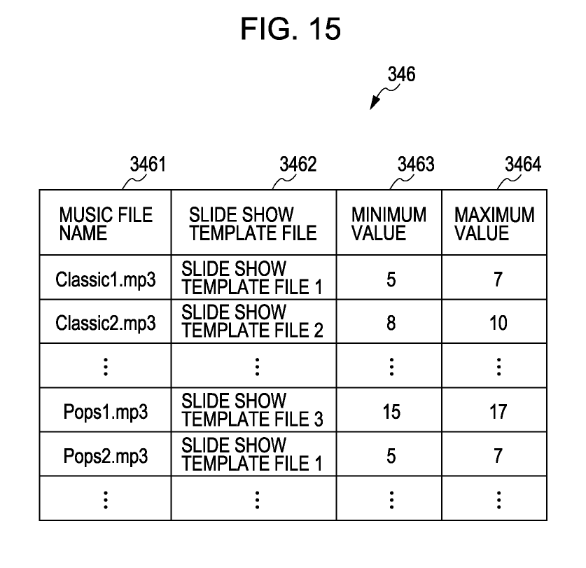

FIG. 15 illustrates the content of the music file mapping table 346 in accordance with one embodiment of the present invention. The music file mapping table 346 includes a music file 3461 stored on the music file storage unit 252, a slide show template file name 3462, a minimum value 3463, and a maximum value 3464.

The slide show template file name 3462 contains a file name of a slide show template file in which elements required for the slide show, such as a motion and a speed of the motion of a display image in the slide show, are described. As shown in FIG. 15, the slide show template file name as the template file of the pre-generated slide show is stored in the slide show template file name 3462. The minimum value 3463 and the maximum value 3464 represent the minimum value and the maximum value of the permissible range of the number of image files referenced in the slide show template file.

In the content of the music file mapping table 346, the elements required for the slide show, such as the motion and the speed of the motion of a display image in the slide show, are described as parameters using the music file name and the number of image files, instead of storing the music file 3461 and the slide show template file name corresponding to the minimum value 3463 and the maximum value 3464 as the range of the number of image files.

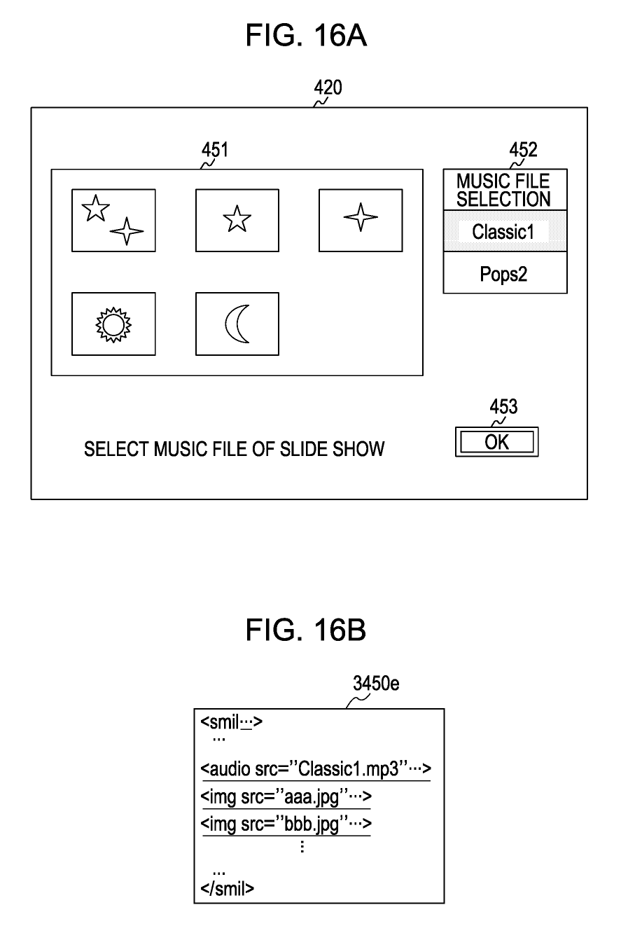

FIG. 16A illustrates a display screen 420 for the image pickup apparatus 100 that generates the slide show file in accordance with one embodiment of the present invention. The display screen 420 appears after the image file is selected on the image file selection screen (not shown).

When the slide show file is generated, the display screen 420 includes an image file display 451, a music file selection display 452, and an OK button 453. The image file display 451 shows the image file selected on the image file selection screen (not shown). When any of the music files displayed on the music file selection display 452 is selected followed by the selection of the OK button 453, a slide show file is generated.

The music files displayed on the music file selection display 452 may be all music files stored on the music file storage unit 252, or only music files corresponding to the number of selected image files.

FIG. 16B illustrates a generated slide show file 3450e. In accordance with the present embodiment, the slide show file is generated by writing the selected image file and information relating to the music file onto the slide show template file. The music file selected in FIG. 16A is described as <audio src=“Classic1.mp3” . . . > in the generated slide show file 3450e, and the image file selected on the image file selection screen (not shown) is described as rimg src=“aaa.jpg” . . . > in the slide show file 3450c.

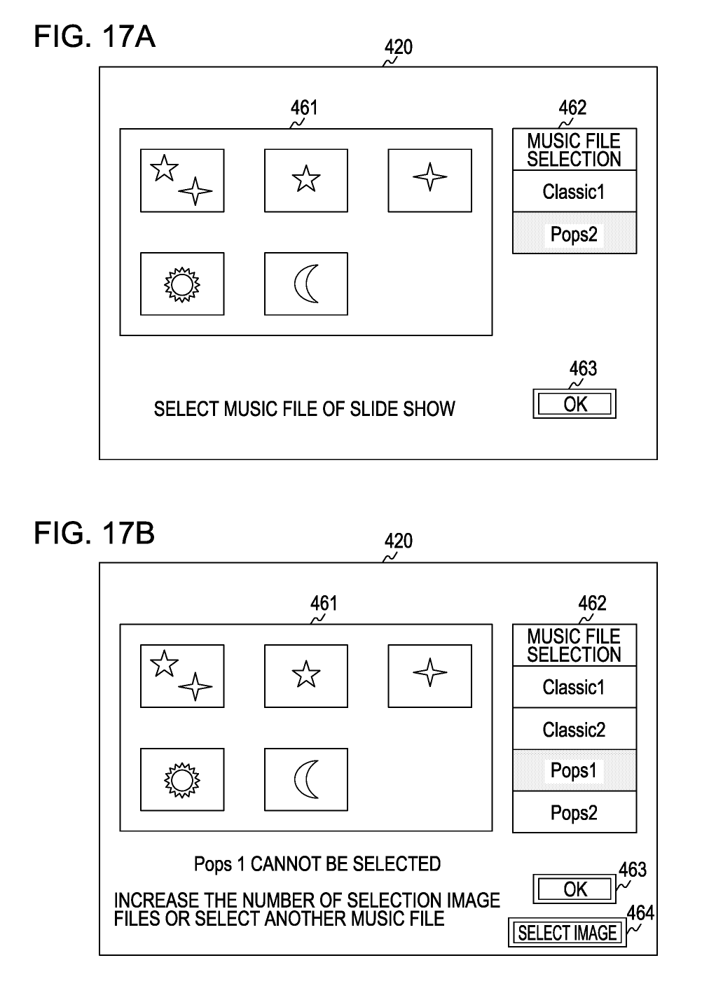

FIGS. 17A and 17B illustrate limitation imposed on the selection of the music file in the generation of the slide show file. FIG. 17A illustrates the display screen 420 that displays as a music file selection display 462 only the music files corresponding to the number of selected image files. As previously discussed with reference to FIG. 15, one of the functions available from the music file presenter 3172 is to present only the music files corresponding to the number of selected image files. The mapping of the number of selected image files with the music file is described in the music file mapping table 346.

For example, four music files “Classic1,” “Classic2,” “Pops1,” and “Pops2” might be stored on the music file storage unit 252. In such a case, only the “Classic1” and “Pops2” corresponding to five as the number of image files are displayed as shown in FIG. 7A, and one of the “Classic1” and “Pops2” may be selected.

FIG. 17B illustrates how the selection of the music files are limited on the display screen 420. As previously discussed with reference to FIG. 15, another one of the functions available from the music file presenter 3172 is to present all music files contained in the music file mapping table 346 and select only music files corresponding to the number of selected image files.

If four music files “Classic1,” “Classic2,” “Pops1,” and “Pops2” are stored on the music file storage unit 252 in the same way as shown in FIG. 17A, this information is also described on the music file mapping table 346. As shown in FIG. 17B, four music files “Classic1,” “Classic2,” “Pops1,” and “Pops2” contained in the music file mapping table 346 are displayed on the music file selection display 462. If the music file “Pops1” is selected as a music file, the number of image files D corresponding to the music file “Pops1” falls within range 15≦D≦17, and does not match the number of image files shown on an image file display 461.

If “Pops1” is selected as a music file followed by the selection of an OK button 463, a message appears reading “Pops1 cannot be selected. Increase the number of selection image files or select another music file.” An image selection button 464 may be selected to “increase the number of selection image files”, and the image file selection screen (not shown) appears. On the other hand, another music file may be selected on the screen of FIG. 17B to “select another music file.”

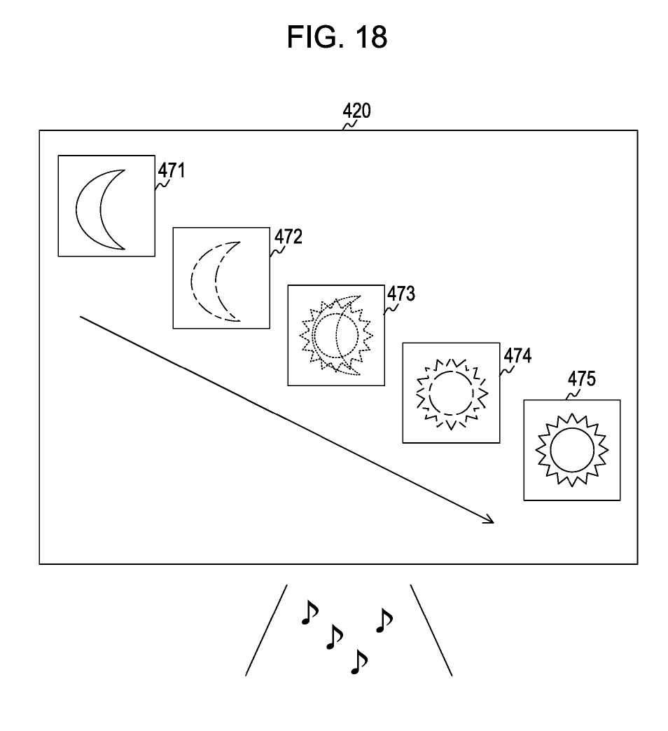

FIG. 18 illustrates a slide show when the slide show file is executed in accordance with one embodiment of the present invention. If the slide show file is selected after the image file and the music file are selected, an image file 471 representing the moon gradually moves downward right as an image file 472 on the display screen 420 of FIG. 18, thereby fading out. In an image file 473, an image of the moon fading out and an image of the sun to be displayed fading in are displayed in an overlapping manner. As the images further moves downward right, the image of the moon disappears while an image file 474 representing the sun gradually fades in. When the image reaches the bottom right corner, an image file 475 representing the sun clearly appears. The music file is reproduced while the slide show advances described above.

Operation of the image pickup apparatus 100 of one embodiment of the present invention is described below with reference to the drawings.

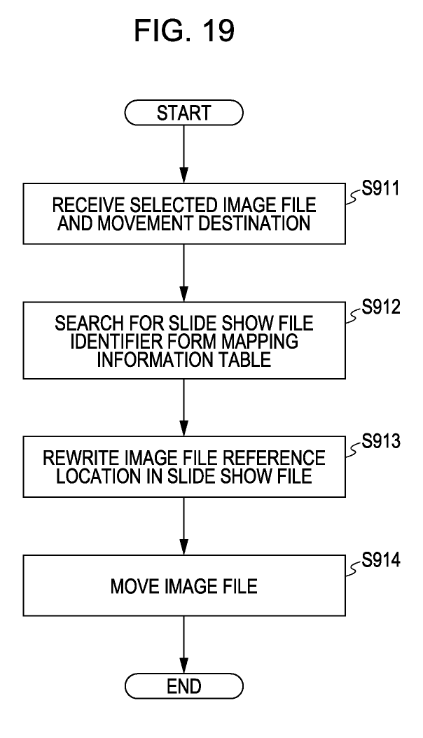

FIG. 19 illustrates the flow of correction process of the slide show file in accordance with one embodiment of the present invention. The movement designation receiver 411 receives the image file to be moved and the designation of the movement destination of the image file (step S911). When the movement designation receiver 411 receives the image file to be moved and the designation of the movement destination of the image file, the slide show file identifier searcher 3121 searches the mapping information table 341 for the slide show file identifier corresponding to the selected image file identifier (step S912).

The image file reference location rewriter 3122 rewrites, in accordance with the selected movement destination, the reference location of the image file in the slide show file corresponding to the slide show file identifier found in the search (step S913). The file mover 3110 moves the image file selected in step S911 to the movement destination (step S914). The movement of the image file can be performed at any time subsequent to step S911.

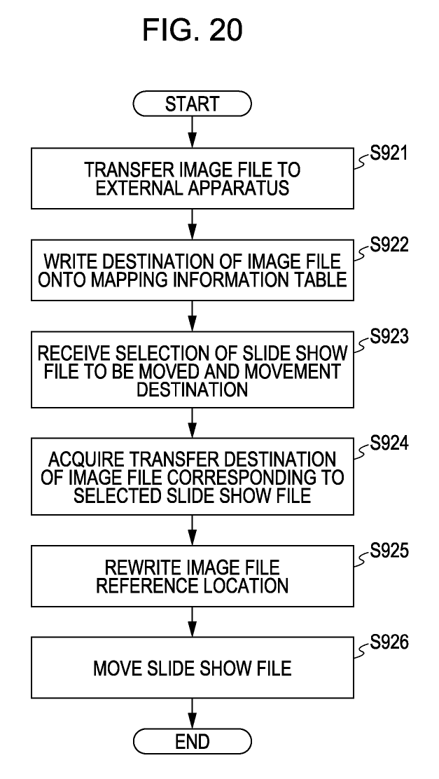

FIG. 20 illustrates the flow of correction process in accordance with another embodiment of the present invention. The image file transfer unit 3142 transfers to an external apparatus the master image file stored on the image file storage unit 251 (step S921). When the master image file is transferred from the image file storage unit 251 to the external apparatus, the image file transfer unit 3142 writes the transfer destination of the master image file onto the mapping information table 342 (step S922).

The movement designation receiver 412 receives the slide show file to be moved and the designation of the movement destination of the slide show file (step S923). When the movement designation receiver 412 receives the slide show file to be moved and the designation of the movement destination of the slide show file, the transfer destination acquisition unit 3151 acquires, from the mapping information table 342, the transfer destination of the master image file corresponding to the thumbnail image file referenced in the selected slide show file (step S924).

After the transfer destination of the thumbnail image file is received from the mapping information table 342, the image file reference location rewriter 3152 rewrites, in accordance with the transfer destination of the master image file, the reference location of the image file in the slide show file selected by the movement designation receiver 412 (step S925). The file mover 3141 moves the slide show file selected in step S923 to the selected movement destination (step S926).

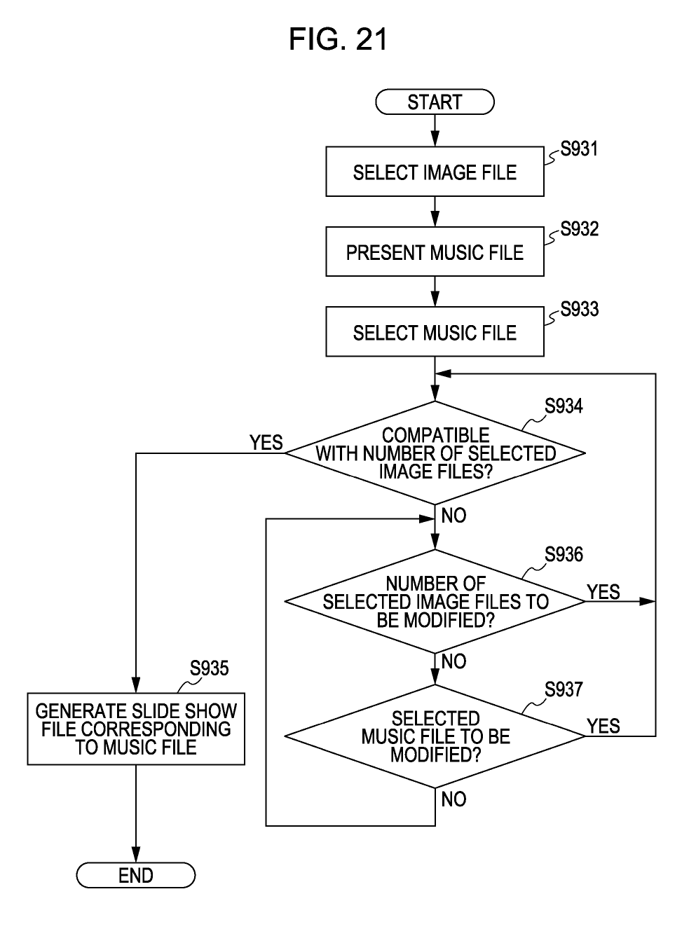

FIG. 21 illustrates the flow of generation process of the slide show file in accordance with one embodiment of the present invention. The file selection receiver 414 receives the selection of the image file for use in the slide show from the image files presented by the image file presenter 3171 (step S931).

When the file selection receiver 414 receives the selection of the image file for use in the slide show, the music file presenter 3172 presents all music files contained in the music file mapping table 346 (step S932). The file selection receiver 414 receives the selection of the music file to be inserted into the slide show from the music files presented by the music file presenter 3172 (step S933).

The music file presenter 3172 determines whether the music file selected in step S933 corresponds to the number of image files, the selection of which is received in step S931 (step S934). This determination is performed by referencing the music file mapping table 346.

If it is determined that the music file selected in step S933 corresponds to the number of image files, the selection of which is received in step S931, the slide show file generator 3180 generates the slide show file (step S935). The slide show file is generated based on the image file with the selection thereof received in step S931, the music file with the selection thereof received in step S933, and the slide show template file corresponding to the music file.

If it is determined that the music file selected in step S933 fails to correspond to the number of image files, the selection of which is received in step S931, the music file presenter 3172 determines whether the number of image files with the selection thereof received in step S931 has been modified (step S936). If it is determined that the number of image files with the selection thereof received in step S931 has been modified, processing returns to step S934. The music file presenter 3172 determines whether the music file selected in step S933 corresponds to the number of image files, the selection of which is received in step S931.

If it is determined that the number of image files with the selection thereof received in step S931 has not been modified, the music file presenter 3172 determines whether the music file with the selection thereof received in step S933 has been modified (step S937).

If it is determined that the music file with the selection thereof received in step S933 has not been modified, processing returns to step S936 to determine whether the number of image files with the selection thereof received in step S931 has been modified. If it is determined that the music file with the selection thereof received in step S933 has been modified, processing returns to step S934 to determine whether the music file corresponds to the number of image files.

In accordance with the embodiments of the present invention, the image file can be referenced even if the image file referenced in the external reference type slide show file discussed with reference to FIG. 1 is moved. The slide show is performed without missing the image file that has moved in the slide show file. The slide show is also performed in a manner free an execution error in the slide show file. With a simple operation of selecting the image file and the music file, the slide show file with music and image matching each other is generated.

In the discussion of the embodiments, the image control apparatus is the image pickup apparatus. The present invention is applicable to electronic apparatuses other than the image pickup apparatus. The embodiments of the present invention have been discussed for exemplary purposes only. As will be discussed below, the elements in each embodiment correspond to the elements in each claim. The present invention is not limited to the correspondence discussed below, and various changes are possible in the correspondence without departing from the scope of the present invention.

In one embodiment of the present invention, the image file storage unit corresponds to the image file storage unit 251. The slide show file storage unit corresponds to the slide show file storage unit 345. The movement designation receiving unit corresponds to the movement designation receiver 411. The file moving unit corresponds to the file mover 3110. The mapping information table corresponds to the mapping information table 341. The slide show file correcting unit corresponds to the slide show file corrector 3120.

In one embodiment of the present invention, the slide show file identifier search unit corresponds to the slide show file identifier searcher 3121. The image file reference location rewriting unit corresponds to the image file reference location rewriter 3122.

In one embodiment of the present invention, the music file storage unit corresponds to the music file storage unit 252. The slide show template file storage unit corresponds to the slide show template file storage unit 347. The music file mapping table corresponds to the music file mapping table 346. The image file presenting unit corresponds to the image file presenter 3171. The image file selection receiving unit corresponds to the file selection receiver 414. The music file presenting unit corresponds to the music file presenter 3172. The music file selection receiving unit corresponds to the file selection receiver 414. The slide show file generating unit corresponds to the slide show file generator 3180.

In one embodiment of the present invention, the mapping information table generating unit corresponds to the mapping information table generator 3190.

In one embodiment of the present invention, the keyword receiving unit corresponds to the keyword receiver 415. The image file searching unit corresponds to the image file searcher 3160.

In one embodiment of the present invention, the image file storage unit corresponds to the image file storage unit 251. The image file transfer unit corresponds to the image file transfer unit 3142. The slide show file storage unit corresponds to the slide show file storage unit 345. The movement designation receiving unit corresponds to the movement designation receiver 412. The file moving unit corresponds to the file mover 3141. The mapping information table corresponds to the mapping information table 342. The slide show file correcting unit corresponds to the slide show file corrector 3150.

In one embodiment of the present invention, the transfer command receiving unit corresponds to the transfer command receiver 413.

In one embodiment of the present invention, the transfer destination acquisition unit corresponds to the transfer destination acquisition unit 3151. The image file reference location rewriting unit corresponds to the image file reference location rewriter 3152.

In one embodiment of the present invention, the master image file storage unit corresponds to the image file storage unit 251. The representative image file storage unit corresponds to the image file storage unit 251. The master image file transfer unit corresponds to the image file transfer unit 3142. The slide show file storage unit corresponds to the slide show file storage unit 345. The file moving unit corresponds to the file mover 3141. The mapping information table corresponds to the mapping information table 342. The slide show file correcting unit corresponds to the slide show file corrector 3150.

In one embodiment of the present invention, the transfer command receiving unit corresponds to the transfer command receiver 413.

In one embodiment of the present invention, the image file storage unit corresponds to the image file storage unit 251. The slide show file storage unit corresponds to the slide show file storage unit 345. The mapping information table corresponds to the mapping information table 341. The movement designation receiving step corresponds to step S911 and S922. The file moving step corresponds to step S914. The slide show file correcting step corresponds to steps S912 and S913.

In one embodiment of the present invention, the image file storage unit corresponds to the image file storage unit 251. The slide show file storage unit corresponds to the slide show file storage unit 345. The mapping information table corresponds to the mapping information table 342. The image file transfer step corresponds to steps S921 and S922. The movement designation receiving step corresponds to step S923. The file movement step corresponds to step S926. The slide show file correcting step corresponds to steps S924 and S925.

In one embodiment of the present invention, the master image file storage unit corresponds to the image file storage unit 251. The representative image file storage unit corresponds to the image file storage unit 251. The slide show file storage unit corresponds to the slide show file storage unit 345. The mapping information table corresponds to the mapping information table 342. The master image file transfer step corresponds to steps S921 and S922. The movement designation receiving step corresponds to step S923. The file movement step corresponds to step S926. The slide show file correcting step corresponds to steps S924 and S925.

The process discussed with reference to the embodiments of the present invention may be considered as a method containing a series of steps. The process may be also considered as a program for causing a computer to perform the series of steps. The program may be stored on a recording medium.

It should be understood by those skilled in the art that various modifications, combinations, sub-combinations and alterations may occur depending on design requirements and other factors insofar as they are within the scope of the appended claims or the equivalents thereof.

What is claimed is:

1. An image control apparatus comprising:
image file storage means for storing an image file;
slide show file storage means for storing a slide show file describing the content of a slide show through which each image file is reproduced successively in order;
movement designation receiving means for receiving the image file to be moved and designation of a movement destination of the image file;
file moving means for moving the image file to the movement destination in accordance with the designation;
a mapping information table for mapping an image file identifier of the image file to be used in the slide show to a slide show file identifier of the slide show file; and
slide show file correcting means for correcting, in accordance with the movement destination, a reference location of the image file in the slide show file having a slide show file identifier corresponding to the image file identifier of the designated image file.

2. The image control apparatus according to claim 1, wherein the slide show file correcting means comprises:
slide show file identifier search means for searching the mapping information table for the slide show file identifier corresponding to the image file identifier of the image file designated by the movement designation receiving means; and
image file reference location rewriting means for rewriting, in accordance with the movement destination, the reference location of the image file used in the slide show of the slide show file having the slide show file identifier found in the search.

3. The image control apparatus according to claim 1, further comprising:
music file storage means for storing a music file;
slide show template file storage means for storing a template file of the slide show;
a music file mapping table for mapping a music file identifier of the music file to a slide show template file identifier of the template file of the slide show;
image file presenting means for presenting the image file stored on the image file storage means;
image file selection receiving means for receiving the selection of the image file presented by the image file presenting means;
music file presenting means for presenting the music file stored on the music file storage means;
music file selection receiving means for receiving the selection of the music file presented by the music file presenting means; and
slide show file generating means for generating a slide show file based on the music file selected by the music file selection receiving means, the template file of the slide show having the slide show template file identifier corresponding to the music file identifier of the music file, and the image file selected by the image file selection receiving means.

4. The image control apparatus according to claim 3, wherein the music file mapping table maps the number of image files, selected by the image file selection receiving means, to the music file identifier, and
wherein the music file presenting means presents, in accordance with the music file mapping table, the music file corresponding to the number of image files selected by the image file selection receiving means.

5. The image control apparatus according to claim 4, wherein the music file mapping table defines a permissible range to the number of image files selected by the image file selection receiving means.

6. The image control apparatus according to claim 3, wherein the music file mapping table maps the number of image files, selected by the image file selection receiving means, to the music file identifier, and
wherein the music file presenting means causes the music file selection receiving means to receive only the music file corresponding to the number of image files selected by the image file selection receiving means.

7. The image control apparatus according to claim 3, further comprising mapping information table generating means for generating the mapping information table based on the image file for use in the selected slide show and the slide show file generated by the slide show file generating means.

8. The image control apparatus according to claim 7, wherein the mapping information table generating means generates the mapping information table containing attribute information of the image file, and comprises:
keyword receiving means for receiving a keyword; and
image file searching means for searching an image file corresponding to the attribute information containing the keyword,
wherein the image file presenting means presents the image file found in the search.

9. An image control apparatus comprising:
image file storage means for storing an image file;
image file transfer means for transferring the image file stored on the image file storage means to another apparatus;
slide show file storage means for storing a slide show file describing the content of a slide show through which each image file is reproduced successively in order;
movement designation receiving means for receiving designation of a slide show file to be moved;
file moving means for moving the slide show file in accordance with the designation;
a mapping information table for mapping an image file identifier of the image file to be used in the slide show, a slide show file identifier of the slide show file of the slide show, and a transfer destination of the transferred image file; and
slide show file correcting means for correcting, in accordance with the transfer destination, a reference location of an image file in the slide show file, the image file having an image file identifier corresponding to the slide show file identifier of the designated slide show file.

10. The image control apparatus according to claim 9, further comprising transfer command receiving means for receiving a command to transfer the image file stored on the image file storage means to the other apparatus,
wherein the image file transfer means transfers the image file stored on the image file storage means to the other apparatus in response to the command from the transfer command receiving means.

11. The image control apparatus according to claim 9, wherein the slide show file correcting means comprises:
transfer destination acquisition means for acquiring, in accordance with the mapping information table, the transfer destination of the image file corresponding to the slide show file designated by the movement designation receiving means; and
image file reference location rewriting means for rewriting, in accordance with the transfer destination, the reference location of the image file to be used in the slide show of the slide show file.

12. The image control apparatus according to claim 9, the mapping information table contains an address of the other apparatus as the transfer destination of the image file.

13. An image control apparatus comprising:
master image file storage means for storing a master image file;
representative image file storage means for storing a representative image file of the master image file;
master image file transfer means for transferring the master image file stored on the master image file storage means to another apparatus;
slide show file storage means for storing a slide show file that describes the content of a slide show through which each representative image file stored on the representative image file storage means is reproduced successively in order;
movement designation receiving means for receiving designation of the slide show file to be moved;
file moving means for moving the slide show file in accordance with the designation;
a mapping information table for mapping a representative image file identifier of the representative image file to be used in the slide show, a slide show file identifier of a slide show file corresponding to the slide show, a master image file identifier of the master image file corresponding to the representative image file, and a transfer destination of the transferred master image file; and
slide show file correcting means for correcting the slide show file so that the file to be used in the slide show is changed from the representative image file to the master image file in accordance with the mapping information table.

14. The image control apparatus according to claim 13, further comprising transfer command receiving means for receiving a command to transfer the master image file stored on the master image file storage means to the other apparatus,
wherein the master image file transfer means transfers the master image file stored on the master image file storage means to the other apparatus in response to the command from the transfer command receiving means.

15. A method of an image control apparatus including image file storage means for storing an image file, slide show file storage means for storing a slide show file describing the content of a slide show through which each image file is reproduced successively in order, and a mapping information table for mapping an image file identifier of the image file to be used in the slide show to a slide show file identifier of the slide show file of the slide show, the method comprising the steps of:
receiving the image file to be moved and designation of a movement destination of the image file;
moving the image file to the movement destination in accordance with the designation; and
correcting, in accordance with the movement destination, a reference location of the image file in the slide show file having the slide show file identifier corresponding to the image file identifier of the designated image file.

16. A method of an image control apparatus for transferring an image file stored on image file storage means to an external apparatus as a transfer destination, including the image file storage means for storing the image file, slide show file storage means for storing a slide show file describing the content of a slide show through which each image file is reproduced successively in order, and a mapping information table for mapping an image file identifier of the image file to be used in the slide show, a slide show file identifier of the slide show file of the slide show, and the transfer destination of the image file, the method comprising the steps of:
transferring the image file stored on the image file storage means to the external apparatus as the transfer destination and storing the transfer destination in the mapping information table;
receiving designation of the slide show file to be moved;
moving the slide show file in accordance with the designation; and
correcting, in accordance with the transfer destination, a reference location of the image file in the slide show file, the image file having an image file identifier corresponding to the slide show file identifier of the designated slide show file.

17. A method of an image control apparatus for transferring a master image file stored on master image file storage means to an external apparatus as a transfer destination, including the master image file storage means for storing the master image file, representative image file storage means for storing a representative image file of the master image file, slide show file storage means for storing a slide show file that describes the content of a slide show through which each representative image file stored on the representative image file storage means is reproduced successively in order, and a mapping information table for mapping a representative image file identifier of the representative image file to be used in the slide show, a slide show file identifier of the slide show file of the slide show, a master image file identifier of the master image file corresponding to the representative image file, and the transfer destination of the transferred master image file, the method comprising the steps of:
transferring the master image file stored on the master image file storage means to the other apparatus;
receiving designation of the slide show file to be moved;
moving the slide show file in accordance with the designation; and
correcting the slide show file so that the file to be used in the slide show is changed from the representative image file to the master image file in accordance with the mapping information table.

18. A program for an image control apparatus including image file storage means for storing an image file, slide show file storage means for storing a slide show file describing the content of a slide show through which each image file is reproduced successively in order, and a mapping information table for mapping an image file identifier of the image file to be used in the slide show to a slide show file identifier of the slide show file of the slide show, the program comprising the steps of:
receiving the image file to be moved and designation of a movement destination of the image file;
moving the image file to the movement destination in accordance with the designation; and
correcting, in accordance with the movement destination, a reference location of the image file in the slide show file having the slide show file identifier corresponding to the image file identifier of the designated image file.

19. A program for an image control apparatus for transferring an image file stored on image file storage means to an external apparatus as a transfer destination, including the image file storage means for storing the image file, slide show file storage means for storing a slide show file describing the content of a slide show through which each image file is reproduced successively in order, and a mapping information table for mapping an image file identifier of the image file to be used in the slide show, a slide show file identifier of the slide show file of the slide show, and the transfer destination of the image file, the program comprising the steps of:
transferring the image file stored on the image file storage means to the external apparatus as the transfer destination and storing the transfer destination in the mapping information table;
receiving designation of the slide show file to be moved;
moving the slide show file in accordance with the designation; and
correcting, in accordance with the transfer destination, a reference location of the image file in the slide show file, the image file having an image file identifier corresponding to the slide show file identifier of the designated slide show file.

20. A program for an image control apparatus for transferring a master image file stored on master image file storage means to an external apparatus as a transfer destination, including the master image file storage means for storing the master image file, representative image file storage means for storing a representative image file of the master image file, slide show file storage means for storing a slide show file that describes the content of a slide show through which each representative image file stored on the representative image file storage means is reproduced successively in order, and a mapping information table for mapping a representative image file identifier of the representative image file to be used in the slide show, a slide show file identifier of the slide show file of the slide show, a master image file identifier of the master image file corresponding to the representative image file, and the transfer destination of the transferred master image file, the program comprising the steps of:
transferring the master image file stored on the master image file storage means to the other apparatus;
receiving designation of the slide show file to be moved;
moving the slide show file in accordance with the designation; and
correcting the slide show file so that the file to be used in the slide show is changed from the representative image file to the master image file in accordance with the mapping information table.

21. An image control apparatus comprising:
an image file storage unit storing an image file;
a slide show file storage unit storing a slide show file describing the content of a slide show through which each image file is reproduced successively in order;
a movement designation receiving unit receiving the image file to be moved and designation of a movement destination of the image file;
a file moving unit moving the image file to the movement destination in accordance with the designation;
a mapping information table mapping an image file identifier of the image file to be used in the slide show to a slide show file identifier of the slide show file; and
a slide show file correcting unit correcting, in accordance with the movement destination, a reference location of the image file in the slide show file having a slide show file identifier corresponding to the image file identifier of the designated image file.

22. An image control apparatus comprising:
an image file storage unit storing an image file;
an image file transfer unit transferring the image file stored on the image file storage unit to another apparatus;
a slide show file storage unit storing a slide show file describing the content of a slide show through which each image file is reproduced successively in order;
a movement designation receiving unit receiving designation of a slide show file to be moved;
a file moving unit moving the slide show file in accordance with the designation;
a mapping information table mapping an image file identifier of the image file to be used in the slide show, a slide show file identifier of the slide show file of the slide show, and a transfer destination of the transferred image file; and
a slide show file correcting unit correcting, in accordance with the transfer destination, a reference location of an image file in the slide show file, the image file having an image file identifier corresponding to the slide show file identifier of the designated slide show file.

23. An image control apparatus comprising:
a master image file storage unit storing a master image file;
a representative image file storage unit storing a representative image file of the master image file;
a master image file transfer unit transferring the master image file stored on the master image file storage unit to another apparatus;
a slide show file storage unit storing a slide show file that describes the content of a slide show through which each representative image file stored on the representative image file storage unit is reproduced successively in order;
a movement designation receiving unit receiving designation of the slide show file to be moved;
a file moving unit moving the slide show file in accordance with the designation;
a mapping information table mapping a representative image file identifier of the representative image file to be used in the slide show, a slide show file identifier of a slide show file corresponding to the slide show, a master image file identifier of the master image file corresponding to the representative image file, and a transfer destination of the transferred master image file; and
a slide show file correcting unit correcting the slide show file so that the file to be used in the slide show is changed from the representative image file to the master image file in accordance with the mapping information table.
